(19) United States
(12) Patent Application Publication
(10) Pub. No.: US 2025/0208381 A1
(43) Pub. Date: Jun. 26, 2025

(54) OPTICAL IMAGING SYSTEM

(71) Applicant: Samsung Electro-Mechanics Co., Ltd., Suwon-si (KR)

(72) Inventors: Do Hyeong JANG, Suwon-si (KR); Hag Chul KIM, Suwon-si (KR); Seong Il CHO, Suwon-si (KR)

(73) Assignee: Samsung Electro-Mechanics Co., Ltd., Suwon-si (KR)

(21) Appl. No.: 18/972,447

(22) Filed: Dec. 6, 2024

(30) Foreign Application Priority Data
Dec. 26, 2023 (KR) 10-2023-0191799

(51) Int. Cl. G02B 13/00; G02B 9/60; G02B 13/02

(52) U.S. Cl. CPC G02B 13/0045; G02B 9/60; G02B 13/02

(57) ABSTRACT

An optical imaging system includes a first lens having refractive power; a second lens having negative refractive power; a third lens having refractive power; a fourth lens having positive refractive power; and a fifth lens having negative refractive power. The first to fifth lenses are disposed in order from an object side, wherein 3.10<f/IMG HT<3.15 is satisfied, where f is a focal length of the optical imaging system, and IMG HT is half of a diagonal length of an imaging plane.

### CROSS-REFERENCE TO RELATED APPLICATIONS

This application claims the benefit under 35 USC 119(a) of Korean Patent Application No. 10-2023-0191799 filed on Dec. 26, 2023, in the Korean Intellectual Property Office, the entire disclosure of which is incorporated herein by reference for all purposes.

### BACKGROUND

### 1. Field

The present disclosure relates to an optical imaging system including five lenses.

### 2. Description of the Background

Slimmer mobile devices that include cameras with medium magnification (ex. 2.5˜3.5 magnification), which were previously implemented as direct-type systems, are being implemented as folded types. However, since medium magnification cameras generally use high-pixel image sensors with a large number of pixels, there may be a problem in which the focal length and full length are inevitably increased.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having refractive power; a second lens having negative refractive power; a third lens having refractive power; a fourth lens having positive refractive power; and a fifth lens having negative refractive power. The first to fifth lenses are disposed in order from an object side, wherein 3.10<f/IMG HT<3.15 is satisfied, where f is a focal length of the optical imaging system, and IMG HT is half of a diagonal length of an imaging plane.

3.7≤TTL/ΣCTn(n=1, 2, 3)≤4.3 may be satisfied, where TTL is a distance on an optical axis from an object-side surface of the first lens to the imaging plane, and ΣCTn (n=1, 2, 3) is a sum of thicknesses on the optical axis of the first to third lenses.

The first lens may have a convex image-side surface. 0.2≤R1/f≤0.3 may be satisfied, where R1 is a radius of curvature of an object-side surface of the first lens.

−2.5<f/f2+f/f3<−1.5 may be satisfied, where f2 is a focal length of the second lens, and f3 is a focal length of the third lens.

2.0<TTL/f1≤2.5 may be satisfied, where TTL is a distance on an optical axis from an object-side surface of the first lens to the imaging plane, and f1 is a focal length of the first lens.

The third lens may have positive refractive power and a convex object-side surface.

2.15<f/BFL<2.60 may be satisfied, where BFL is a distance on an optical axis from an image-side surface of the fifth lens to the imaging plane.

The third lens may have negative refractive power.

5<d2/d1 may be satisfied, where d2 is a distance on an optical axis between an image-side surface of the second lens and an object-side surface of the third lens, and d1 is a distance on the optical axis between an image-side surface of the first lens and an object-side surface of the second lens.

The optical imaging system may further include an optical path conversion member disposed on an object side of the first lens.

The optical imaging system may have a total of five lenses.

In another general aspect, an optical imaging system includes a first lens, a second lens, a third lens, a fourth lens, and a fifth lens, sequentially arranged from an object side, wherein 0.9≤TTL/f≤0.95 and 3.10<f/IMG HT<3.15 are satisfied, where TTL is a distance on an optical axis from an object-side surface of the first lens to an imaging plane, f is a focal length of the optical imaging system, and IMG HT is half a diagonal length of the imaging plane.

The optical imaging system may further include an optical path conversion member disposed on the object-side of the first lens.

0.19<DL12/TTL<0.23 may be satisfied, where DL12 is a distance on the optical axis from the object-side surface of the first lens to an image-side surface of the second lens.

The first lens may be a D-cut lens, wherein 1.8<AR1+AR2<2.0 is satisfied, where AR1 is an aspect ratio of a maximum effective diameter of the first lens, and AR2 is an aspect ratio of a maximum effective diameter of the second lens.

The fifth lens may have a convex object-side surface and a concave image-side surface.

0<|f/f3|<0.6 may be satisfied, where f3 is a focal length of the third lens.

The optical imaging system may have a total of five lenses.

Other features and aspects will be apparent from the following detailed description, the drawings, and the claims.

### BRIEF DESCRIPTION OF DRAWINGS

FIG. 1A is an optical imaging system configuration diagram according to a first embodiment of the present disclosure.

FIG. 1B is a graph illustrating aberration characteristics of an optical imaging system according to the first embodiment of the present disclosure.

FIG. 2A is an optical imaging system configuration diagram according to a second embodiment.

FIG. 2B is a graph illustrating aberration characteristics of the optical imaging system according to the second embodiment of the present disclosure.

FIG. 3A is an optical imaging system configuration diagram according to a third embodiment of the present disclosure.

FIG. 3B is a graph illustrating aberration characteristics of the optical imaging system according to the third embodiment of the present disclosure.

FIG. 4A is an optical imaging system configuration diagram according to a fourth embodiment of the present disclosure.

FIG. 4B is a graph illustrating aberration characteristics of the optical imaging system according to the fourth embodiment of the present disclosure.

FIG. 5A is an optical imaging system configuration diagram according to a fifth embodiment of the present disclosure.

FIG. 5B is a graph illustrating aberration characteristics of the optical imaging system according to the fifth embodiment of the present disclosure.

FIG. 6A is an optical imaging system configuration diagram according to a sixth embodiment of the present disclosure.

FIG. 6B is a graph illustrating aberration characteristics of the optical imaging system according to the sixth embodiment of the present disclosure.

FIG. 7A is an optical imaging system configuration diagram according to a seventh embodiment of the present disclosure.

FIG. 7B is a graph illustrating aberration characteristics of the optical imaging system according to the seventh embodiment of the present disclosure.

FIG. 8A is an optical imaging system configuration diagram according to an eighth embodiment of the present disclosure.

FIG. 8B is a graph illustrating aberration characteristics of the optical imaging system according to the eighth embodiment of the present disclosure.

FIG. 9A is an optical imaging system configuration diagram according to a ninth embodiment of the present disclosure.

FIG. 9B is a graph illustrating aberration characteristics of the optical imaging system according to the ninth embodiment of the present disclosure.

FIG. 10A is an optical imaging system configuration diagram according to a tenth embodiment of the present disclosure.

FIG. 10B is a graph illustrating aberration characteristics of the optical imaging system according to the tenth embodiment of the present disclosure.

FIG. 11 is a configuration diagram of an optical imaging system of the present disclosure, including an optical path conversion member.

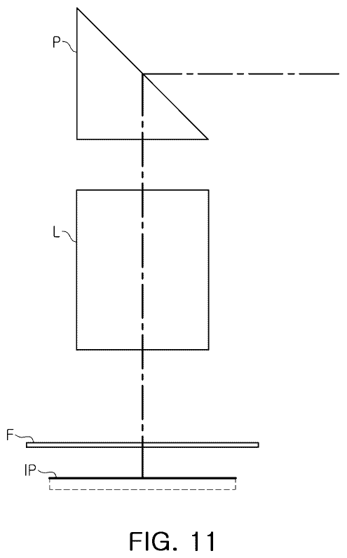

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein.

However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In this specification, the units for a radius of curvature of a lens, a thickness, a gap or a distance, a focal length, IMG HT (½ of a diagonal length of an imaging plane), and effective radius (semi-aperture) are all mm, and the unit of field of view (FOV) is degree. In addition, a thickness of a lens and a gap between lenses may refer to a thickness and a gap on an optical axis, respectively.

In this specification, an object side may indicate a direction in which an object is disposed, and an image side may indicate, for example, a direction in which an imaging plane having an image formed thereon is disposed or a direction in which an image sensor is disposed.

In the description related to a shape of a lens in this specification, the disclosure that one surface is convex means that a paraxial region (a very narrow area near an optical axis) of the corresponding surface is convex, and the disclosure that the one surface is concave means that the paraxial region of the corresponding surface is concave. Accordingly, even if one surface of the lens is described as having a convex shape, an edge portion of the lens may be concave. Similarly, even if one surface of the lens is described as having a concave shape, an edge portion of the lens may have a convex shape.

An optical imaging system according to embodiments of the present disclosure may be employed in a camera of a mobile device. The optical imaging system according to embodiments may be a camera mounted on the front side of a mobile device. Mobile devices may be any type of portable electronic device, such as a mobile communication terminal, smartphone, or tablet PC.

In embodiments of the present disclosure, an optical imaging system may include five lenses L. In embodiments, the optical imaging system may include a first lens, a second lens, a third lens, a fourth lens, and a fifth lens arranged in order from the object side.

In addition, the optical imaging system may not be comprised of only five lenses, but may further include an image sensor converting incident light into an electrical signal, an infrared blocking filter blocking light in an infrared region incident on the image sensor, and an aperture adjusting the amount of light incident on the lens. In embodiments of the present disclosure, the aperture may be disposed between the second lens and the third lens.

Additionally, the optical imaging system may further include an optical path conversion member (e.g., a prism) P bending the path of incident light.

In embodiments of the present disclosure, the imaging optical system may include a lens formed of a plastic material. In embodiments, at least one of the first to fifth lenses may be formed of plastic lens, and preferably, all of the first to fifth lenses may be formed of plastic lenses.

In embodiments of the present disclosure, an optical imaging system may include an aspherical lens. In embodiments, at least one of the first to fifth lenses may be an aspherical lens, and preferably, all of the first to fifth lenses may be aspherical lenses. At least one of an object-side surface and an image-side surface of the first to fifth lenses may be aspherical. The aspherical surface of the lens may be expressed by Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad Equation 1$$

In Equation 1, c represents an inverse number of a radius of curvature of a lens, K represents a conic constant, and Y indicates a distance from any point on an aspherical surface of the lens to an optical axis. In addition, constants A to H, J, and L to P are aspherical constants from fourth to thirtieth order in order, and Z (or SAG) is a distance in an optical axis direction between any point on the aspherical surface and the vertex of the corresponding aspherical surface.

The optical imaging system may satisfy the following conditional expressions in embodiments of the present disclosure.

$$Conditional Expression 1 : 1.8 < AR 1 + AR 2 < 2.$$

$$Conditional Expression 2 : 0.9 \leq TTL / f \leq 0.95$$

$$Conditional Expression 3 : 5.1 < TTL * BFL / f < 6.3$$

$$Conditional Expression 4 : 2.15 < f / BFL < 2.60$$

$$Conditional Expression 5 : 3.1 < f / IMG HT < 3.15$$

$$Conditional Expression 6 : 0.19 < DL 12 / TTL < 0.23$$

$$Conditional Expression 7 : 2.5 < DL 12 / TTL * f < 2.8$$

$$Conditional Expression 8 : 100 < DL 15 * f < 115$$

$$Conditional Expression 9 : 0.2 < EDL 1 / f < 0.25$$

In Conditional Expression 1, AR1 is an aspect ratio of a maximum effective diameter of a first lens, and AR2 is an aspect ratio of the maximum effective diameter of a second lens. Conditional Expression 1 relates to a characteristic in which an optical imaging system has a thin thickness according to embodiments of the present disclosure.

In Conditional Expression 2 to Conditional Expression 4, TTL is a distance on an optical axis from an object-side surface of a first lens to an imaging plane, BFL is a distance on an optical axis from an image-side surface of a fifth lens to the imaging plane, and f is a focal length of an optical imaging system. Conditional expression 2 is a telephoto ratio conditional expression, and may be viewed as a telephoto camera when the given range is satisfied. Conditional Expression 3 and Conditional Expression 4 relate to a characteristic in which the optical imaging system of the embodiments of the present disclosure has telephoto characteristics.

In Conditional Equation 5, f is a focal length of an optical imaging system, and IMG HT is half a diagonal length of an imaging plane. Conditional Expression 5 relates to a characteristic in which the optical imaging system has a thin thickness according to embodiments of the present disclosure.

In Conditional Expression 6 to Conditional Expression 8, DL12 is a distance on an optical axis from an object-side surface of the first lens to an image-side surface of the second lens, DL15 is a distance on the optical axis from the object-side surface of the first lens to the image-side surface of the fifth lens, TTL is a distance on the optical axis from the object-side surface of the first lens to the imaging plane, and f is a focal length of the optical imaging system. Conditional Expression 6 and Conditional Expression 7 relate to the optical characteristics of the first lens and the second lens for the optical imaging system according to embodiments of the present disclosure to have telephoto characteristics. Conditional Expression 8 relates to the characteristics of the optical imaging system according to embodiments of the present disclosure, which have a long focal length and a short length.

In Conditional Equation 9, EDL1 is a maximum effective radius of an object-side surface of the first lens, and f is a focal length of the optical imaging system. Conditional Expression 9 is related to shape conditions of the first lens for the optical imaging system according to embodiments of the present disclosure to have appropriate brightness performance and focal length.

In embodiments of the present disclosure, the optical imaging system may additionally satisfy the following conditional expressions.

$$Conditional Expression 10 : 2.0 < f / f 1 < 3.$$

$$Conditional Expression 11 : - 3. < f / f 2 < - 1.$$

$$Conditional Expression 12 : 0 < \vert f / f 3 \vert < 0.6$$

$$Conditional Expression 13 : 0 < f / f 4 < 1.3$$

$$Conditional Expression 14 : - 1.2 < f / f 5 < - 0.4$$

$$Conditional Expression 15 : - 1.2 < f 1 / f 2 < - 0.6$$

$$Conditional Expression 16 : 0 < \vert f 2 / f 3 \vert < 0.3$$

$$Conditional Expression 17 : - 2.5 < f / f 2 + f / f 3 < - 1.5$$

$$Conditional Expression 18 : 2 \text{.0} < TTL / f 1 \leq 2.5$$

$$Conditional Expression 19 : 0.2 \leq R 1 / f \leq 0.3$$

$$Conditional Expression 20 : 5 < d 2 / d 1$$

$$Conditional Expression 21 : 0.5 < EDL 4 / EDL 1 < 0.8$$

$$Conditional Expression 22 : 3.7 \leq TTL / Σ CTn \leq 4.3 , ( n = 1 , 2 , 3 )$$

In Conditional Expression 10 to Conditional Expression 17, f is a focal length of the optical imaging system, f1 is a focal length of the first lens, f2 is a focal length of the second lens, f3 is a focal length of the third lens, f4 is a focal length of the fourth lens, and f5 is a focal length of the fifth lens. Conditional Expression 10 to Conditional Expression 17 are related to an aberration correction performance of the imaging optical system according to embodiments of the present disclosure.

In Conditional Expression 18, TTL is a distance on the optical axis from the object-side surface of the first lens to the imaging plane, and f1 is a focal length of the first lens. In Conditional Expression 19, R1 is a radius of curvature of the object-side surface of the first lens, and f is a focal length of the optical imaging system. Conditional Expression 18 and Conditional Expression 19 are related to the design conditions of the first lens for ensuring which the optical imaging system according to embodiments of the present disclosure having telephoto characteristics.

In Conditional Expression 20, d2 is a distance on an optical axis between the image-side surface of the second lens and the object-side surface of the third lens, and d1 is a distance on an optical axis between the image-side surface of the first lens and the object-side surface of the second lens. Conditional Expression 20 is related to a spacing condition between lenses according to a refractive power of the first to third lenses to secure the performance (focal distance, chromatic aberration, etc.) of the optical imaging system according to the embodiments of the present disclosure.

In Conditional Expression 21, EDL4 is a maximum effective radius of the first lens, and EDL1 is a maximum effective radius of the first lens. Conditional Expression 21 is related to the lens effective diameter condition for the optical imaging system according to the embodiments of the present disclosure to have appropriate brightness performance.

In Conditional Expression 22, TTL is a distance on the optical axis from the object-side surface of the first lens to the imaging plane, ΣCTn (n=1, 2, 3) is a sum of the thicknesses on an optical axis of the first to third lenses. Conditional Expression 22 is related to the manufacturing and assembly of the optical imaging system according to embodiments of the present disclosure.

Hereinafter, an optical imaging system according to embodiments of the present disclosure will be described with reference to the attached drawings.

### First Embodiment

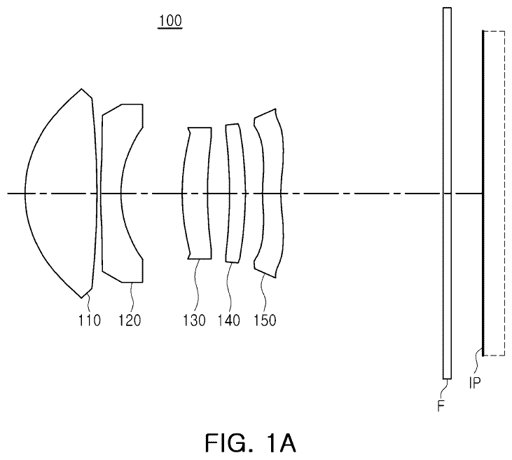

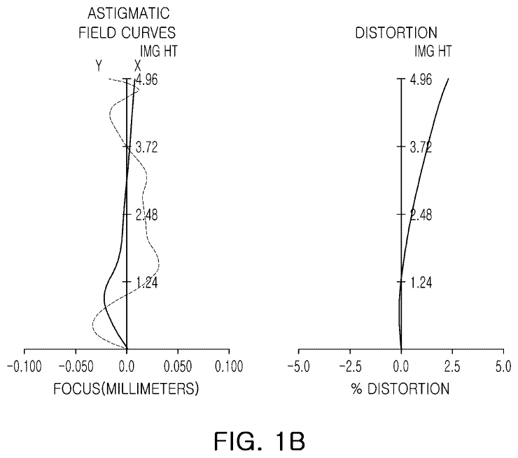

FIG. 1A is a configuration diagram of an optical imaging system according to a first embodiment of the present disclosure, and FIG. 1B is a graph illustrating aberration characteristics of the optical imaging system according to a first embodiment of the present disclosure.

According to the first embodiment, the optical imaging system 100 may include a first lens 110, a second lens 120, a third lens 130, a fourth lens 140, and a fifth lens 150 arranged in order from an object side, and may further include an infrared blocking filter (F) and an image sensor (IP (Imaging Plane)) disposed on the image side of the fifth lens 150. In addition, although not illustrated in the drawing, an optical path conversion member (e.g., a prism) bending the path of incident light may be disposed on the object side of the first lens 110.

The first lens 110 may have positive refractive power. A focal length of the first lens 110 may be 5.0 mm or more. An object-side surface and an image-side surface of the first lens 110 may have a convex shape in the paraxial region. The first lens 110 may be formed of a plastic material. An Abbe number of the first lens 110 may be 50 or more. The first lens 110 may be an aspherical lens. For example, an object-side surface and an image-side surface of the first lens 110 may be aspherical. The first lens 110 may be a D-cut lens having a straight portion on the edge.

The second lens 120 may have negative refractive power. A focal length of the second lens 120 may be less than −5.0 mm. An object-side surface of the second lens 120 may be convex in a paraxial region, and an image-side surface of the second lens 120 may be concave in the paraxial region. The second lens 120 may be formed of a plastic material. For example, the second lens 120 may be formed of a plastic material having different optical properties (refractive index and Abbe number) from the first lens 110. An Abbe number of the second lens 120 may be 20 or more. The second lens 120 may be an aspherical lens. For example, an object-side surface and an image-side surface of the second lens 120 may be aspherical.

The third lens 130 may have positive refractive power. A focal length of the third lens 130 may be 30.0 mm or more. An object-side surface of the third lens 130 may be convex in a paraxial region, and an image-side surface of the third lens 130 may be concave in the paraxial region. The third lens 130 may be formed of a plastic material. For example, the third lens 130 may be formed of a plastic material with different optical properties (refractive index and Abbe number) than the second lens 120. An Abbe number of the third lens 130 may be less than 20. The third lens 130 may be an aspherical lens. For example, an object-side surface and an image-side surface of the third lens 130 may be aspherical.

The fourth lens 140 may have positive refractive power. A focal length of the fourth lens 140 may be 10.0 mm or more. An object-side surface of the fourth lens 140 may be concave in a paraxial region, and an image side surface of the fourth lens 140 may be convex in the paraxial region. The fourth lens 140 may be formed of a plastic material. For example, the fourth lens 140 may be formed of a plastic material with different optical properties (refractive index and Abbe number) than the third lens 130. An Abbe number of the fourth lens 140 may be 20 or more. The fourth lens 140 may be an aspherical lens. For example, an object-side surface and an image-side surface of the fourth lens 140 may be aspherical.

The fifth lens 150 may have negative refractive power. A focal length of the fifth lens 150 may be less than −10.0 mm. An object-side surface of the fifth lens 150 may be convex, and an image-side surface of the fifth lens 150 may be concave. The fifth lens 150 may be formed of a plastic material. For example, the fifth lens 150 may be formed of a plastic material with different optical properties (refractive index and Abbe number) than the fourth lens 140.

An Abbe number of the fifth lens 150 may be 50 or more. The fifth lens 150 may be an aspherical lens. For example, an object-side surface and an image-side surface of the fifth lens 150 may be aspherical.

A focal length of the imaging optical system 100 according to the first embodiment of the present disclosure may be 14.377 mm, TTL may be 13.300 mm, BFL may be 5.859 mm, IMG HT may be 4.608 mm, f value may be 2.55, and HFOV may be 17.45°.

Table 1 below illustrates optical and physical parameters of the optical imaging system 100 according to the first embodiment of the present disclosure.

TABLE 1

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.581 | 2.092 | 1.536 | 55.70 | 5.472 | 2.82(2.70) |
| 3 | −12.978 | 0.105 | | | | 2.61 |
| 4 | 14.934 | 0.589 | 1.618 | 25.90 | −5.572 | 2.41 |
| 5 | 2.759 | 1.800 | | | | 1.95 |
| 6 | 8.009 | 0.709 | 1.676 | 19.20 | 35.502 | 1.77 |
| 7 | 11.583 | 0.650 | | | | 1.64 |
| 8 | −9.671 | 0.469 | 1.618 | 25.90 | 52.822 | 1.84 |
| 9 | −7.601 | 0.506 | | | | 1.89 |
| 10 | 6.868 | 0.520 | 1.545 | 56.30 | −24.627 | 2.03 |
| 11 | 4.423 | 4.731 | | | | 2.28 |
| 12 | Infinity | 0.210 | 1.518 | 64.20 | | 5.00 |
| 13 | Infinity | 0.918 | | | | 5.00 |
| Image | Infinity | | | | | |

Table 2 below illustrates aspheric data of the optical imaging system 100 according to the first embodiment of the present disclosure.

TABLE 2

| Surface | 2 | 3 | 4 | 5 | 6 |
|---|---|---|---|---|---|
| K | −8.95E−01 | −6.28E+01 | −4.29E+01 | −2.59E−01 | −8.85E+00 |
| A | 1.86E−03 | 5.20E−03 | −1.03E−02 | −2.38E−02 | −2.96E−05 |
| B | 1.47E−03 | 1.59E−03 | 7.88E−03 | 1.35E−02 | −3.88E−03 |
| C | −2.03E−03 | −8.73E−03 | −1.64E−02 | −2.79E−02 | 2.08E−02 |
| D | 1.93E−03 | 1.16E−02 | 2.43E−02 | 6.39E−02 | −7.23E−02 |
| E | −1.24E−03 | −9.36E−03 | −2.40E−02 | −1.07E−01 | 1.67E−01 |
| F | 5.53E−04 | 5.14E−03 | 1.66E−02 | 1.28E−01 | −2.57E−01 |
| G | −1.76E−04 | −2.02E−03 | −8.31E−03 | −1.09E−01 | 2.71E−01 |
| H | 4.00E−05 | 5.73E−04 | 3.02E−03 | 6.74E−02 | −2.01E−01 |
| J | −6.56E−06 | −1.18E−04 | −7.95E−04 | −2.99E−02 | 1.06E−01 |
| L | 7.65E−07 | 1.76E−05 | 1.50E−04 | 9.42E−03 | −3.91E−02 |
| M | −6.17E−08 | −1.84E−06 | −1.99E−05 | −2.06E−03 | 9.95E−03 |
| N | 3.27E−09 | 1.27E−07 | 1.74E−06 | 2.95E−04 | −1.66E−03 |
| O | −1.02E−10 | −5.27E−09 | −9.07E−08 | −2.51E−05 | 1.63E−04 |
| P | 1.43E−12 | 9.84E−11 | 2.13E−09 | 9.54E−07 | −7.19E−06 |
| Surface | 7 | 8 | 9 | 10 | 11 |
| K | −7.26E+01 | 2.07E+01 | 2.70E+00 | −6.88E+01 | −6.90E+01 |
| A | 3.36E−03 | 1.70E−02 | 3.95E−04 | −4.77E−02 | 2.53E−02 |
| B | −7.36E−03 | −2.17E−02 | 1.08E−02 | 1.68E−02 | −9.03E−02 |
| C | 1.09E−02 | 8.01E−02 | −6.95E−03 | −1.52E−02 | 1.21E−01 |
| D | −1.44E−02 | −1.94E−01 | 2.54E−03 | 1.86E−02 | −1.18E−01 |
| E | 2.48E−02 | 3.12E−01 | −5.77E−04 | −1.72E−02 | 8.46E−02 |
| F | −5.10E−02 | −3.53E−01 | 1.44E−04 | 1.06E−02 | −4.55E−02 |
| G | 8.12E−02 | 2.87E−01 | −5.27E−05 | −4.03E−03 | 1.83E−02 |
| H | −8.73E−02 | −1.69E−01 | 1.18E−05 | 6.43E−04 | −5.48E−03 |
| J | 6.30E−02 | 7.23E−02 | −9.87E−07 | 1.90E−04 | 1.21E−03 |
| L | −3.08E−02 | −2.22E−02 | 0.00E+00 | −1.45E−04 | −1.93E−04 |
| M | 1.01E−02 | 4.73E−03 | 0.00E+00 | 4.15E−05 | 2.16E−05 |
| N | −2.11E−03 | −6.67E−04 | 0.00E+00 | −6.60E−06 | −1.58E−06 |
| O | 2.57E−04 | 5.56E−05 | 0.00E+00 | 5.75E−07 | 6.79E−08 |
| P | −1.38E−05 | −2.07E−06 | 0.00E+00 | −2.15E−08 | −1.27E−09 |

### Second Embodiment

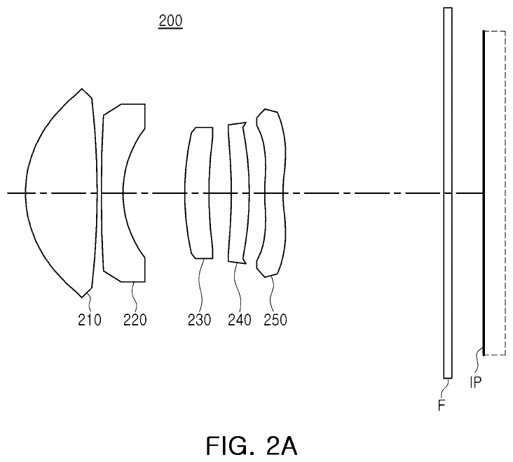

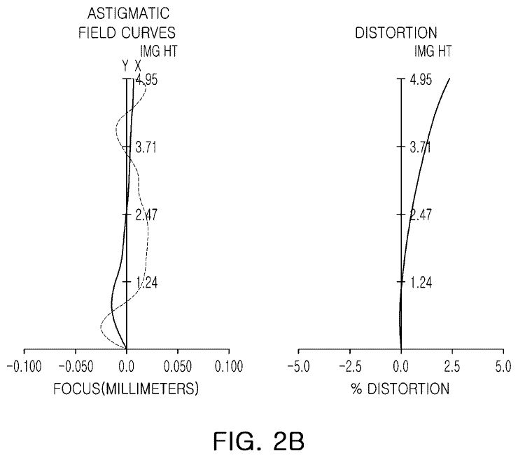

FIG. 2A is an optical imaging system configuration diagram according to a second embodiment of the present disclosure. FIG. 2B is a graph illustrating aberration characteristics of an optical imaging system according to a second embodiment of the present disclosure.

According to the second embodiment, the optical imaging system 200 may include a first lens 210, a second lens 220, a third lens 230, a fourth lens 240, and a fifth lens 250 arranged in order from an object side, and may further include an infrared blocking filter (F) and an image sensor (IP (Imaging Plane)) disposed on the image side of the fifth lens 250. In addition, although not illustrated in the drawing, an optical path conversion member (e.g., a prism) bending the path of incident light may be disposed on the object side of the first lens 210.

The first lens 210 may have positive refractive power. A focal length of the first lens 210 may be 5.0 mm or more. An object-side surface and an image-side surface of the first lens 210 may have a convex shape in a paraxial region. The first lens 210 may be formed of a plastic material. An Abbe number of the first lens 210 may be 50 or more. The first lens 210 may be an aspherical lens. For example, an object-side surface and an image-side surface of the first lens 210 may be aspherical. The first lens 210 may be a D-cut lens having a straight portion on the edge.

The second lens 220 may have negative refractive power. A focal length of the second lens 220 may be less than −5.0 mm. An object-side surface of the second lens 220 may be convex in a paraxial region, and an image-side surface of the second lens 220 may be concave in the paraxial region. The second lens 220 may be formed of a plastic material. For example, the second lens 220 may be formed of a plastic material having different optical properties (refractive index and Abbe number) from the first lens 210. An Abbe number of the second lens 220 may be 20 or more. The second lens 220 may be an aspherical lens. For example, an object-side surface and an image-side surface of the second lens 220 may be aspherical.

The third lens 230 may have positive refractive power. A focal length of the third lens 230 may be 30.0 mm or more. An object-side surface of the third lens 230 may be convex in a paraxial region, and an image-side surface of the third lens 230 may be concave in the paraxial region. The third lens 230 may be formed of a plastic material. For example, the third lens 230 may be formed of a plastic material having different optical properties (refractive index and Abbe number) from the second lens 220. An Abbe number of the third lens 230 may be less than 20. The third lens 230 may be an aspherical lens. For example, an object-side surface and an image-side surface of the third lens 230 may be aspherical.

The fourth lens 240 may have positive refractive power. A focal length of the fourth lens 240 may be 10.0 mm or more. An object-side surface of the fourth lens 240 may be concave in a paraxial region, and an image-side surface of the fourth lens 240 may be convex in the paraxial region. The fourth lens 240 may be formed of a plastic material. For example, the fourth lens 240 may be formed of a plastic material with different optical properties (refractive index and Abbe number) from the third lens 230. An Abbe number of the fourth lens 240 may be 20 or more. The fourth lens 240 may be an aspherical lens. For example, an object-side surface and an image-side surface of the fourth lens 240 may be aspherical.

The fifth lens 250 may have negative refractive power. A focal length of the fifth lens 250 may be less than −10.0 mm. An object-side surface of the fifth lens 250 may be convex, and an image-side surface of the fifth lens 250 may be concave. The fifth lens 250 may be formed of a plastic material. For example, the fifth lens 250 may be formed of a plastic material with different optical properties (refractive index and Abbe number) than the fourth lens 240.

An Abbe number of the fifth lens 250 may be 50 or more. The fifth lens 250 may be an aspherical lens. For example, an object-side surface and an image-side surface of the fifth lens 250 may be aspherical.

A focal length of the optical imaging system 200, according to the second embodiment of the present disclosure, may be 14.337 mm, TTL may be 13.297 mm, BFL may be 5.800 mm, IMG HT may be 4.595 mm, f value may be 2.54, and HFOV may be 15.456.

Table 3 below illustrates optical and physical parameters of the optical imaging system 200 according to the second embodiment of the present disclosure.

TABLE 3

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.580 | 2.079 | 1.536 | 55.70 | 5.456 | 2.82(2.70) |
| 3 | −12.745 | 0.101 | | | | 2.62 |
| 4 | 15.327 | 0.656 | 1.618 | 25.90 | −5.524 | 2.41 |
| 5 | 2.751 | 1.795 | | | | 1.92 |
| 6 | 8.488 | 0.711 | 1.676 | 19.20 | 46.227 | 1.77 |
| 7 | 11.253 | 0.647 | | | | 1.64 |
| 8 | −10.215 | 0.520 | 1.618 | 25.90 | 33.739 | 1.84 |
| 9 | −6.994 | 0.466 | | | | 1.90 |
| 10 | 7.089 | 0.522 | 1.545 | 56.11 | −22.454 | 2.04 |
| 11 | 4.375 | 4.730 | | | | 2.28 |
| 12 | Infinity | 0.210 | 1.518 | 64.20 | | 5.00 |
| 13 | Infinity | 0.860 | | | | 5.00 |
| Image | Infinity | | | | | |

Table 4 below illustrates aspheric data of the optical imaging system 200 according to the second embodiment of the present disclosure.

TABLE 4

| Surface | 2 | 3 | 4 | 5 | 6 |
|---|---|---|---|---|---|
| K | −8.71E−01 | −6.17E+01 | −4.33E+01 | −9.73E−02 | −6.82E+00 |
| A | 1.85E−03 | 3.92E−03 | −9.60E−03 | −2.26E−02 | −1.03E−01 |
| B | 1.39E−03 | 1.74E−03 | 7.70E−03 | 1.30E−02 | −2.25E−03 |
| C | −2.02E−03 | −7.74E−03 | −1.63E−02 | −2.89E−02 | 1.25E−03 |
| D | 2.03E−03 | 1.00E−02 | 2.43E−02 | 6.46E−02 | 1.16E−02 |
| E | −1.38E−03 | −7.84E−03 | −2.40E−02 | −1.11E−01 | −3.56E−02 |
| F | 6.55E−04 | 4.18E−03 | 1.67E−02 | 1.33E−01 | 5.64E−02 |
| G | −2.23E−04 | −1.58E−03 | −8.33E−03 | −1.14E−01 | −5.74E−02 |
| H | 5.52E−05 | 4.33E−04 | 3.03E−03 | 7.10E−02 | 4.02E−02 |
| J | −9.88E−06 | −8.62E−05 | −7.98E−04 | −3.17E−02 | −1.99E−02 |
| L | 1.27E−06 | 1.23E−05 | 1.51E−04 | 1.01E−02 | 6.92E−03 |
| M | −1.14E−07 | −1.24E−06 | −1.99E−05 | −2.23E−03 | −1.67E−03 |
| N | 6.81E−09 | 8.30E−08 | 1.74E−06 | 3.24E−04 | 2.66E−04 |
| O | −2.43E−10 | −3.32E−09 | −9.08E−08 | −2.78E−05 | −2.52E−05 |
| P | 3.90E−12 | 5.99E−11 | 2.13E−09 | 1.07E−06 | 1.08E−06 |
| Surface | 7 | 8 | 9 | 10 | 11 |
| K | −6.38E+01 | 2.25E+01 | 2.72E+00 | −8.58E+01 | −6.86E+01 |
| A | 3.83E−03 | 1.68E−02 | −9.50E−04 | −4.67E−02 | 2.77E−02 |
| B | −1.26E−02 | −9.23E−05 | 3.12E−02 | 1.21E−02 | −1.06E−01 |
| C | 4.08E−02 | −1.57E−02 | −8.44E−02 | −1.20E−02 | 1.57E−01 |
| D | −1.18E−01 | 5.30E−02 | 1.80E−01 | 2.11E−02 | −1.69E−01 |
| E | 2.54E−01 | −1.10E−01 | −2.71E−01 | −2.13E−02 | 1.36E−01 |
| F | −3.93E−01 | 1.49E−01 | 2.84E−01 | 1.00E−02 | −8.31E−02 |
| G | 4.36E−01 | −1.37E−01 | −2.12E−01 | 8.45E−04 | 3.84E−02 |
| H | −3.49E−01 | 8.86E−02 | 1.14E−01 | −4.15E−03 | −1.34E−02 |
| J | 2.01E−01 | −4.06E−02 | −4.42E−02 | 2.73E−03 | 3.51E−03 |
| L | −8.21E−02 | 1.32E−02 | 1.23E−02 | −9.86E−04 | −6.72E−04 |
| M | 2.33E−02 | −2.95E−03 | −2.39E−03 | 2.21E−04 | 9.17E−05 |
| N | −4.36E−03 | 4.38E−04 | 3.09E−04 | −3.08E−05 | −8.40E−06 |
| O | 4.82E−04 | −3.86E−05 | −2.39E−05 | 2.44E−06 | 4.63E−07 |
| P | −2.39E−05 | 1.53E−06 | 8.40E−07 | −8.44E−08 | −1.16E−08 |

### Third Embodiment

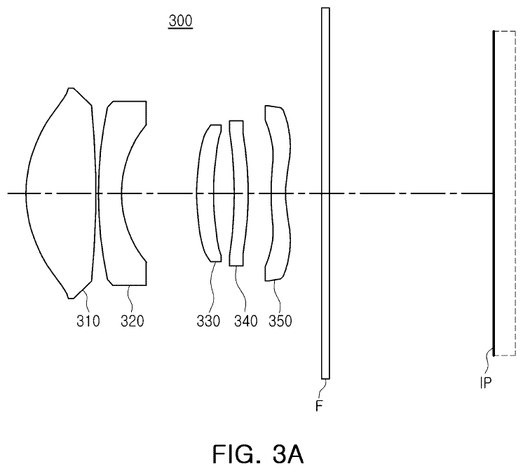

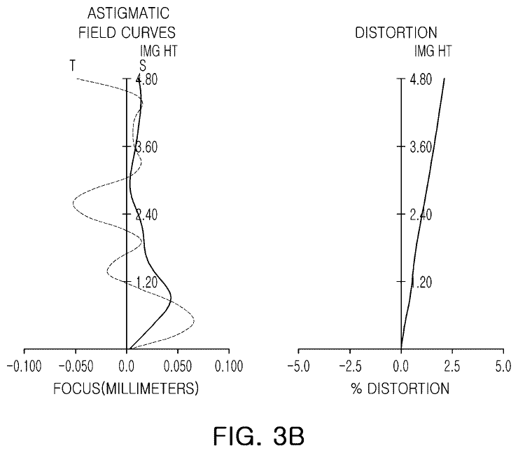

FIG. 3A is an optical imaging system configuration diagram according to a third embodiment of the present disclosure. FIG. 3B is a graph illustrating aberration characteristics of an optical imaging system according to a third embodiment of the present disclosure.

According to the third embodiment, the optical imaging system 300 may include a first lens 310, a second lens 320, a third lens 330, a fourth lens 340, and a fifth lens 350 arranged in order from an object side, and may further include an infrared blocking filter (F) and an image sensor (IP (Imaging Plane)) disposed on an image side of the fifth lens 350. In addition, although not illustrated in the drawings, an optical path conversion member (e.g., a prism) bending the path of incident light may be disposed on an object side of the first lens 310.

The first lens 310 may have positive refractive power. A focal length of the first lens 310 may be 5.0 mm or more. An object-side surface and an image-side surface of the first lens 310 may have a convex shape in a paraxial region. The first lens 310 may be formed of a plastic material. An Abbe number of the first lens 310 may be 50 or more. The first lens 310 may be an aspherical lens. For example, an object-side surface and an image-side surface of the first lens 310 may be aspherical. The first lens 310 may be a D-cut lens having a straight portion on the edge.

The second lens 320 may have negative refractive power. A focal length of the second lens 320 may be less than −5.0 mm. An object-side surface of the second lens 320 may be convex in a paraxial region, and an image-side surface of the second lens 320 may be concave in the paraxial region. The second lens 320 may be formed of a plastic material. For example, the second lens 320 may be formed of a plastic material having different optical properties (refractive index and Abbe number) from the first lens 310. An Abbe number of the second lens 320 may be 20 or more. The second lens 320 may be an aspherical lens. For example, an object-side surface and an image-side surface of the second lens 320 may be aspherical.

The third lens 330 may have positive refractive power. A focal length of the third lens 330 may be 30.0 mm or more. An object-side surface of the third lens 330 may be convex in a paraxial region, and an image-side surface of the third lens 330 may be concave in the paraxial region. The third lens 330 may be formed of a plastic material. For example, the third lens 330 may be formed of a plastic material with different optical properties (refractive index and Abbe number) than the second lens 320. An Abbe number of the third lens 330 may be less than 20. The third lens 330 may be an aspherical lens. For example, an object-side surface and an image-side surface of the third lens 330 may be aspherical.

The fourth lens 340 may have positive refractive power. A focal length of the fourth lens 340 may be 10.0 mm or more. An object-side surface of the fourth lens 340 may be concave in a paraxial region, and an image-side surface of the fourth lens 340 may be convex in the paraxial region. The fourth lens 340 may be formed of a plastic material. For example, the fourth lens 340 may be formed of a plastic material with different optical properties (refractive index and Abbe number) than the third lens 330. An Abbe number of the fourth lens 340 may be 20 or more. The fourth lens 340 may be an aspherical lens. For example, an object-side surface and an image-side surface of the fourth lens 340 may be aspherical.

The fifth lens 350 may have negative refractive power. A focal length of the fifth lens 350 may be less than −10.0 mm. An object-side surface of the fifth lens 350 may be convex, and an image-side surface of the fifth lens 350 may be concave. The fifth lens 350 may be formed of a plastic material. For example, the fifth lens 350 may be formed of a plastic material with different optical properties (refractive index and Abbe number) than the fourth lens 340. An Abbe number of the fifth lens 350 may be 50 or more. The fifth lens 350 may be an aspherical lens. For example, an object-side surface and an image-side surface of the fifth lens 350 may be aspherical.

The focal length of the optical imaging system 300, according to the third embodiment of the present disclosure, may be 14.337 mm, TTL may be 13.300 mm, BFL may be 5.930 mm, IMG HT may be 4.595 mm, f value may be 2.55, and HFOV may be 17.45°.

Table 5 below illustrates optical and physical parameters of the optical imaging system 300 according to the third embodiment of the present disclosure.

TABLE 5

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.782 | 1.982 | 1.536 | 55.70 | 6.335 | 2.82(2.70) |
| 3 | −27.481 | 0.067 | | | | 2.68 |
| 4 | 7.096 | 0.654 | 1.644 | 23.49 | −7.137 | 2.42 |
| 5 | 2.689 | 2.146 | | | | 1.98 |
| 6 | 6.645 | 0.481 | 1.676 | 19.20 | 65.139 | 1.80 |
| 7 | 7.596 | 0.575 | | | | 1.79 |
| 8 | −9.018 | 0.400 | 1.640 | 23.96 | 29.295 | 1.84 |
| 9 | −6.193 | 0.653 | | | | 1.90 |
| 10 | 4.381 | 0.413 | 1.545 | 56.30 | −21.895 | 2.14 |
| 11 | 3.099 | 1.000 | | | | 2.30 |
| 12 | Infinity | 0.210 | 1.518 | 64.20 | | 5.00 |
| 13 | Infinity | 4.720 | | | | 5.00 |
| Image | Infinity | | | | | |

Table 6 below illustrates aspheric data of the optical imaging system 300 according to the third embodiment of the present disclosure.

TABLE 6

| Surface | 2 | 3 | 4 | 5 | 6 |
|---|---|---|---|---|---|
| K | −1.17E+00 | 1.07E+01 | −1.10E+01 | −1.64E−01 | −1.40E+01 |
| A | 3.13E−03 | −1.30E−03 | −1.17E−02 | −1.99E−02 | −3.69E−03 |
| B | −1.43E−03 | 6.39E−03 | 4.55E−03 | 3.66E−03 | 3.27E−03 |
| C | 2.12E−03 | −2.39E−03 | 9.11E−03 | 5.93E−03 | −6.13E−03 |
| D | −2.00E−03 | −4.17E−03 | −2.06E−02 | −7.68E−03 | 1.62E−02 |
| E | 1.27E−03 | 5.97E−03 | 2.01E−02 | −6.83E−04 | −2.19E−02 |
| F | −5.70E−04 | −3.89E−03 | −1.20E−02 | 9.71E−03 | 2.04E−02 |
| G | 1.85E−04 | 1.59E−03 | 4.74E−03 | −1.08E−02 | −1.50E−02 |
| H | −4.38E−05 | −4.44E−04 | −1.30E−03 | 6.39E−03 | 9.06E−03 |
| J | 7.54E−06 | 8.72E−05 | 2.45E−04 | −2.36E−03 | −4.43E−03 |
| L | −9.36E−07 | −1.21E−05 | −3.13E−05 | 5.59E−04 | 1.66E−03 |
| M | 8.12E−08 | 1.16E−06 | 2.53E−06 | −8.20E−05 | −4.41E−04 |
| N | −4.68E−09 | −7.38E−08 | −1.09E−07 | 6.60E−06 | 7.79E−05 |
| O | 1.61E−10 | 2.78E−09 | 1.07E−09 | −1.83E−07 | −8.09E−06 |
| P | −2.49E−12 | −4.72E−11 | 6.04E−11 | −4.95E−09 | 3.73E−07 |
| Surface | 7 | 8 | 9 | 10 | 11 |
| K | −2.79E+01 | 1.86E+01 | −1.37E+01 | −8.00E+01 | −3.00E+01 |
| A | −1.24E−02 | 2.24E−02 | 1.82E−02 | 3.42E−02 | 4.32E−02 |
| B | 3.69E−02 | −3.68E−02 | −5.71E−02 | −1.27E−01 | −1.31E−01 |
| C | −1.50E−01 | 1.19E−01 | 2.01E−01 | 1.73E−01 | 1.87E−01 |
| D | 3.84E−01 | −2.75E−01 | −4.43E−01 | −1.63E−01 | −1.99E−01 |
| E | −6.42E−01 | 4.41E−01 | 6.58E−01 | 1.07E−01 | 1.59E−01 |
| F | 7.46E−01 | −5.05E−01 | −6.88E−01 | −4.73E−02 | −9.51E−02 |
| G | −6.20E−01 | 4.17E−01 | 5.17E−01 | 1.20E−02 | 4.28E−02 |
| H | 3.74E−01 | −2.52E−01 | −2.83E−01 | −3.41E−04 | −1.45E−02 |
| J | −1.64E−01 | 1.11E−01 | 1.13E−01 | −1.01E−03 | 3.64E−03 |
| L | 5.20E−02 | −3.56E−02 | −3.26E−02 | 4.20E−04 | −6.70E−04 |
| M | −1.15E−02 | 8.00E−03 | 6.58E−03 | −8.99E−05 | 8.76E−05 |
| N | 1.70E−03 | −1.20E−03 | −8.86E−04 | 1.14E−05 | −7.71E−06 |
| O | −1.51E−04 | 1.08E−04 | 7.14E−05 | −8.08E−07 | 4.09E−07 |
| P | 6.01E−06 | −4.38E−06 | −2.60E−06 | 2.49E−08 | −9.86E−09 |

### Fourth Embodiment

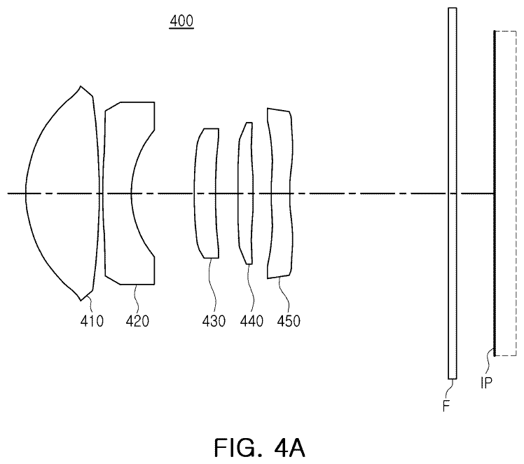

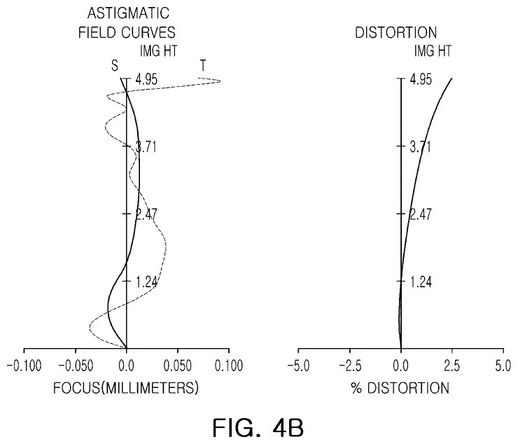

FIG. 4A is an optical imaging system configuration diagram according to a fourth embodiment of the present disclosure. FIG. 4B is a graph illustrating aberration characteristics of an optical imaging system according to a fourth embodiment of the present disclosure.

According to the fourth embodiment, the optical imaging system 400 may include a first lens 410, a second lens 420, a third lens 430, a fourth lens 440, and a fifth lens 450 arranged in order from an object side, and may further include an infrared blocking filter (F) and an image sensor (IP (Imaging Plane)) disposed on an image side of the fifth lens 450. In addition, although not illustrated in the drawing, an optical path conversion member (e.g., a prism) bending the path of incident light may be disposed on an object side of the first lens 410.

The first lens 410 may have positive refractive power. A focal length of the first lens 410 may be 5.0 mm or more. An object-side surface and an image-side surface of the first lens 410 may have a convex shape in a paraxial region. The first lens 410 may be formed of a plastic material. An Abbe number of the first lens 410 may be 50 or more. The first lens 410 may be an aspherical lens. For example, an object-side surface and an image-side surface of the first lens 410 may be aspherical. The first lens 410 may be a D-cut lens having a straight portion on the edge.

The second lens 420 may have negative refractive power. A focal length of the second lens 420 may be less than −5.0 mm. An object-side surface and an image-side surface of the second lens 420 may have a concave shape in a paraxial region. The second lens 420 may be formed of a plastic material. For example, the second lens 420 may be formed of a plastic material with different optical properties (refractive index and Abbe number) from the first lens 410. An Abbe number of the second lens 420 may be 20 or more. The second lens 420 may be an aspherical lens. For example, an object-side surface and an image-side surface of the second lens 420 may be aspherical.

The third lens 430 may have positive refractive power. A focal length of the third lens 430 may be 30.0 mm or more. An object-side surface of the third lens 430 may be convex in a paraxial region, and an image side surface of the third lens 430 may be concave in the paraxial region. The third lens 430 may be formed of a plastic material. For example, the third lens 430 may be formed of a plastic material with different optical properties (refractive index and Abbe number) than the second lens 420. An Abbe number of the third lens 430 may be less than 20. The third lens 430 may be an aspherical lens. For example, an object-side surface and an image-side surface of the third lens 430 may be aspherical.

The fourth lens 440 may have positive refractive power. A focal length of the fourth lens 440 may be 10.0 mm or more. An object-side surface of the fourth lens 440 may be concave in a paraxial region, and an image-side surface of the fourth lens 440 may be convex in the paraxial region. The fourth lens 440 may be formed of a plastic material. For example, the fourth lens 440 may be formed of a plastic material with different optical properties (refractive index and Abbe number) than the third lens 430. An Abbe number of the fourth lens 440 may be 20 or more. The fourth lens 440 may be an aspherical lens. For example, an object-side surface and an image-side surface of the fourth lens 440 may be aspherical.

The fifth lens 450 may have negative refractive power. A focal length of the fifth lens 450 may be less than −10.0 mm. An object-side surface of the fifth lens 450 may be convex, and an image-side surface of the fifth lens 450 may be concave. The fifth lens 450 may be formed of a plastic material. For example, the fifth lens 450 may be formed of a plastic material with different optical properties (refractive index and Abbe number) than the fourth lens 440. An Abbe number of the fifth lens 450 may be 50 or more. The fifth lens 450 may be an aspherical lens. For example, an object-side surface and an image-side surface of the fifth lens 450 may be aspherical.

The focal length of the optical imaging system 400, according to the fourth embodiment of the present disclosure, may be 14.337 mm, TTL may be 13.300 mm, BFL may be 5.800 mm, IMG HT may be 4.595 mm, f value may be 2.54, and HFOV may be 17.45°.

Table 7 below illustrates optical and physical parameters of the optical imaging system 400 according to the fourth embodiment of the present disclosure.

TABLE 7

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.580 | 2.087 | 1.536 | 55.70 | 5.529 | 2.82(2.70) |
| 3 | −13.710 | 0.100 | | | | 2.62 |
| 4 | 12.121 | 0.800 | 1.618 | 25.90 | −5.223 | 2.39 |
| 5 | 2.489 | 1.800 | | | | 1.84 |
| 6 | 11.754 | 0.593 | 1.676 | 19.20 | 55.925 | 1.70 |
| 7 | 16.700 | 0.650 | | | | 1.64 |
| 8 | −22.010 | 0.430 | 1.618 | 25.90 | 21.409 | 1.90 |
| 9 | −8.336 | 0.520 | | | | 2.02 |
| 10 | 7.200 | 0.520 | 1.545 | 56.11 | −20.880 | 2.10 |
| 11 | 4.300 | 4.500 | | | | 2.28 |
| 12 | Infinity | 0.210 | 1.518 | 64.20 | | 5.00 |
| 13 | Infinity | 1.090 | | | | 5.00 |
| Image | Infinity | | | | | |

Table 8 below illustrates aspheric data of the optical imaging system 400 according to the fourth embodiment of the present disclosure.

TABLE 8

| Surface | 2 | 3 | 4 | 5 | 6 |
|---|---|---|---|---|---|
| K | −8.77E−01 | −4.74E+01 | −4.00E+01 | −1.35E−01 | 5.38E−01 |
| A | 1.75E−03 | 3.72E−03 | −7.71E−03 | −2.12E−02 | −2.58E−03 |
| B | 1.58E−03 | 2.09E−03 | 5.88E−03 | 1.11E−02 | 3.37E−03 |
| C | −2.21E−03 | −8.21E−03 | −1.50E−02 | −3.07E−02 | −1.90E−02 |
| D | 2.18E−03 | 1.03E−02 | 2.32E−02 | 7.66E−02 | 6.38E−02 |
| E | −1.49E−03 | −7.90E−03 | −2.35E−02 | −1.31E−01 | −1.28E−01 |
| F | 7.17E−04 | 4.13E−03 | 1.67E−02 | 1.59E−01 | 1.73E−01 |
| G | −2.49E−04 | −1.54E−03 | −8.48E−03 | −1.38E−01 | −1.62E−01 |
| H | 6.24E−05 | 4.13E−04 | 3.13E−03 | 8.74E−02 | 1.08E−01 |
| J | −1.14E−05 | −8.07E−05 | −8.37E−04 | −4.02E−02 | −5.18E−02 |
| L | 1.48E−06 | 1.13E−05 | 1.61E−04 | 1.33E−02 | 1.77E−02 |
| M | −1.34E−07 | −1.12E−06 | −2.15E−05 | −3.07E−03 | −4.24E−03 |
| N | 8.07E−09 | 7.30E−08 | 1.91E−06 | 4.70E−04 | 6.78E−04 |
| O | −2.88E−10 | −2.86E−09 | −1.01E−07 | −4.29E−05 | −6.54E−05 |
| P | 4.61E−12 | 5.05E−11 | 2.40E−09 | 1.77E−06 | 2.89E−06 |
| Surface | 7 | 8 | 9 | 10 | 11 |
| K | −9.87E+01 | 2.25E+01 | −3.28E+01 | −8.60E+01 | −7.92E+01 |
| A | 2.04E−03 | 2.76E−02 | 1.11E−02 | −2.80E−02 | 5.63E−02 |
| B | −1.09E−02 | −7.76E−03 | 1.41E−02 | −1.57E−02 | −1.67E−01 |
| C | 5.27E−02 | −4.96E−03 | −5.29E−02 | 5.37E−02 | 2.73E−01 |
| D | −1.97E−01 | 3.32E−02 | 1.26E−01 | −1.01E−01 | −3.35E−01 |
| E | 4.88E−01 | −7.90E−02 | −1.98E−01 | 1.35E−01 | 3.08E−01 |
| F | −8.10E−01 | 1.15E−01 | 2.14E−01 | −1.28E−01 | −2.12E−01 |
| G | 9.33E−01 | −1.11E−01 | −1.63E−01 | 8.71E−02 | 1.08E−01 |
| H | −7.61E−01 | 7.42E−02 | 8.92E−02 | −4.26E−02 | −4.11E−02 |
| J | 4.42E−01 | −3.51E−02 | −3.52E−02 | 1.50E−02 | 1.15E−02 |
| L | −1.82E−01 | 1.17E−02 | 9.96E−03 | −3.78E−03 | −2.34E−03 |
| M | 5.17E−02 | −2.71E−03 | −1.97E−03 | 6.59E−04 | 3.36E−04 |
| N | −9.68E−03 | 4.11E−04 | 2.59E−04 | −7.59E−05 | −3.22E−05 |
| O | 1.07E−03 | −3.70E−05 | −2.04E−05 | 5.17E−06 | 1.84E−06 |
| P | −5.33E−05 | 1.49E−06 | 7.24E−07 | −1.58E−07 | −4.78E−08 |

### Fifth Embodiment

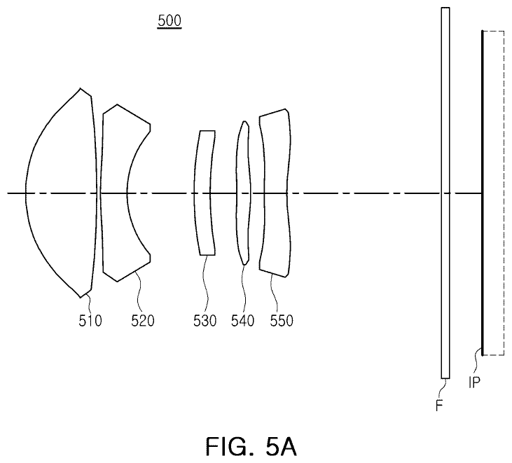

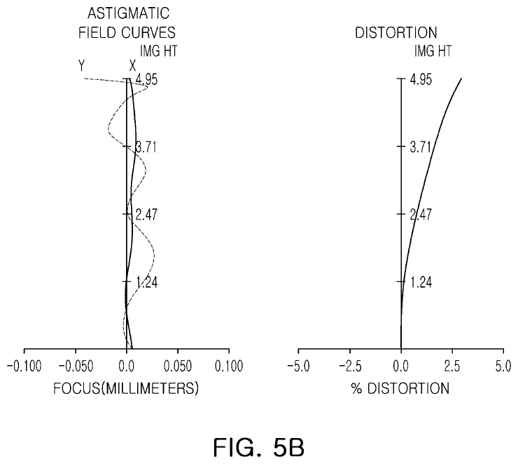

FIG. 5A is an optical imaging system configuration diagram according to a fifth embodiment of the present disclosure. FIG. 5B is a graph illustrating aberration characteristics of an optical imaging system according to a fifth embodiment of the present disclosure.

According to the fifth embodiment, the optical imaging system 500 may include a first lens 510, a second lens 520, a third lens 530, a fourth lens 540, and a fifth lens 550 arranged in order from an object side, and may further include an infrared blocking filter (F) and an image sensor (IP (Imaging Plane)) disposed on an image side of the fifth lens 550. In addition, although not illustrated in the drawing, an optical path conversion member (e.g., a prism) bending the path of incident light may be disposed on an object side of the first lens 510.

The first lens 510 may have positive refractive power. A focal length of the first lens 510 may be 5.0 mm or more. An object-side surface and an image-side surface of the first lens 510 may have a convex shape in a paraxial region. The first lens 510 may be formed of a plastic material. An Abbe number of the first lens 510 may be 50 or more. The first lens 510 may be an aspherical lens. For example, an object-side surface and an image-side surface of the first lens 510 may be aspherical. The first lens 510 may be a D-cut lens with a straight portion on the edge.

The second lens 520 may have negative refractive power. A focal length of the second lens 520 may be less than −5.0 mm. An object-side surface and an image-side surface of the second lens 520 may have a concave shape in a paraxial region. The second lens 520 may be formed of a plastic material. For example, the second lens 520 may be formed of a plastic material with different optical properties (refractive index and Abbe number) from the first lens 510. An Abbe number of the second lens 520 may be 20 or more. The second lens 520 may be an aspherical lens. For example, an object-side surface and an image-side surface of the second lens 520 may be aspherical.

The third lens 530 may have positive refractive power. A focal length of the third lens 530 may be 30.0 mm or more. An object-side surface of the third lens 530 may be convex in a paraxial region, and an image-side surface of the third lens 530 may be concave in a paraxial region. The third lens 530 may be formed of a plastic material. For example, the third lens 530 may be formed of a plastic material with different optical properties (refractive index and Abbe number) than the second lens 520. An Abbe number of the third lens 530 may be less than 20. The third lens 530 may be an aspherical lens. For example, an object-side surface and an image-side surface of the third lens 530 may be aspherical.

The fourth lens 540 may have positive refractive power. A focal length of the fourth lens 540 may be 10.0 mm or more. An object-side surface of the fourth lens 540 may be concave in a paraxial region, and an image-side surface of the fourth lens 540 may be convex in the paraxial region. The fourth lens 540 may be formed of a plastic material. For example, the fourth lens 540 may be formed of a plastic material with different optical properties (refractive index and Abbe number) than the third lens 530. An Abbe number of the fourth lens 540 may be 20 or more. The fourth lens 540 may be an aspherical lens. For example, an object-side surface and an image-side surface of the fourth lens 540 may be aspherical.

The fifth lens 550 may have negative refractive power. A focal length of the fifth lens 550 may be less than −10.0 mm. An object-side surface of the fifth lens 550 may be convex, and an image-side surface of the fifth lens 550 may be concave. The fifth lens 550 may be formed of a plastic material. For example, the fifth lens 550 may be formed of a plastic material with different optical properties (refractive index and Abbe number) than the fourth lens 540. An Abbe number of the fifth lens 550 may be 50 or more. The fifth lens 550 may be an aspherical lens. For example, an object-side surface and an image-side surface of the fifth lens 550 may be aspherical.

The focal length of the optical imaging system 500, according to the fifth embodiment of the present disclosure, may be 14.337 mm, TTL may be 13.301 mm, BFL may be 5.703 mm, IMG HT may be 4.595 mm, f value may be 2.55, and HFOV may be 17.37°.

Table 9 below illustrates optical and physical parameters of the optical imaging system 500 according to the fifth embodiment of the present disclosure.

TABLE 9

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.604 | 2.080 | 1.536 | 55.70 | 5.545 | 2.82(2.70) |
| 3 | −13.554 | 0.100 | | | | 2.60 |
| 4 | 12.335 | 0.764 | 1.619 | 25.90 | −5.421 | 2.38 |
| 5 | 2.576 | 1.965 | | | | 1.86 |
| 6 | 12.117 | 0.478 | 1.667 | 19.20 | 83.444 | 1.65 |
| 7 | 15.248 | 0.750 | | | | 1.67 |
| 8 | −21.838 | 0.406 | 1.619 | 25.90 | 14.567 | 1.94 |
| 9 | −6.429 | 0.405 | | | | 2.02 |
| 10 | 15.692 | 0.650 | 1.545 | 56.11 | −14.154 | 2.07 |
| 11 | 5.102 | 4.500 | | | | 2.28 |
| 12 | Infinity | 0.210 | 1.518 | 64.20 | | 5.00 |
| 13 | Infinity | 0.993 | | | | 5.00 |
| Image | Infinity | | | | | |

Table 10 below illustrates aspheric data of the optical imaging system 500 according to the fifth embodiment of the present disclosure.

TABLE 10

| Surface | 2 | 3 | 4 | 5 | 6 |
|---|---|---|---|---|---|
| K | −8.64E−01 | −5.03E+01 | −4.06E+01 | −1.07E−01 | 3.18E+00 |
| A | 1.98E−03 | 3.77E−03 | −7.88E−03 | −2.10E−02 | 8.39E−04 |
| B | 1.24E−03 | 2.07E−03 | 6.05E−03 | 1.09E−02 | −2.61E−02 |
| C | −1.90E−03 | −8.23E−03 | −1.51E−02 | −2.68E−02 | 1.47E−01 |
| D | 2.02E−03 | 1.04E−02 | 2.34E−02 | 6.46E−02 | −4.89E−01 |
| E | −1.44E−03 | −7.97E−03 | −2.36E−02 | −1.12E−01 | 1.05E+00 |
| F | 7.17E−04 | 4.18E−03 | 1.67E−02 | 1.39E−01 | −1.54E+00 |
| G | −2.53E−04 | −1.56E−03 | −8.50E−03 | −1.24E−01 | 1.58E+00 |
| H | 6.43E−05 | 4.20E−04 | 3.14E−03 | 8.06E−02 | −1.15E+00 |
| J | −1.18E−05 | −8.22E−05 | −8.41E−04 | −3.78E−02 | 6.04E−01 |
| L | 1.54E−06 | 1.16E−05 | 1.62E−04 | 1.26E−02 | −2.26E−01 |
| M | −1.39E−07 | −1.14E−06 | −2.17E−05 | −2.94E−03 | 5.88E−02 |
| N | 8.36E−09 | 7.49E−08 | 1.93E−06 | 4.51E−04 | −1.01E−02 |
| O | −2.98E−10 | −2.93E−09 | −1.02E−07 | −4.10E−05 | 1.03E−03 |
| P | 4.76E−12 | 5.19E−11 | 2.44E−09 | 1.68E−06 | −4.74E−05 |
| Surface | 7 | 8 | 9 | 10 | 11 |
| K | −8.63E+01 | 2.25E+01 | −3.04E+01 | −8.60E+01 | −6.93E+01 |
| A | 2.44E−04 | 2.68E−02 | 1.52E−02 | −3.07E−02 | 2.19E−02 |
| B | 2.45E−03 | −1.17E−02 | −6.54E−03 | 1.79E−02 | −5.16E−02 |
| C | −3.61E−03 | 2.78E−02 | 2.77E−02 | −3.22E−02 | 5.53E−02 |
| D | −2.98E−02 | −8.55E−02 | −8.86E−02 | 3.97E−02 | −4.49E−02 |
| E | 1.30E−01 | 1.60E−01 | 1.65E−01 | −2.41E−02 | 2.96E−02 |
| F | −2.57E−01 | −1.90E−01 | −1.96E−01 | −1.92E−04 | −1.63E−02 |
| G | 3.16E−01 | 1.52E−01 | 1.57E−01 | 1.25E−02 | 7.38E−03 |
| H | −2.63E−01 | −8.51E−02 | −8.81E−02 | −1.09E−02 | −2.69E−03 |
| J | 1.53E−01 | 3.37E−02 | 3.51E−02 | 5.20E−03 | 7.52E−04 |
| L | −6.25E−02 | −9.38E−03 | −9.88E−03 | −1.59E−03 | −1.56E−04 |
| M | 1.76E−02 | 1.80E−03 | 1.92E−03 | 3.20E−04 | 2.28E−05 |
| N | −3.24E−03 | −2.26E−04 | −2.46E−04 | −4.11E−05 | −2.22E−06 |
| O | 3.54E−04 | 1.67E−05 | 1.87E−05 | 3.06E−06 | 1.29E−07 |
| P | −1.73E−05 | −5.48E−07 | −6.35E−07 | −1.01E−07 | −3.35E−09 |

### Sixth Embodiment

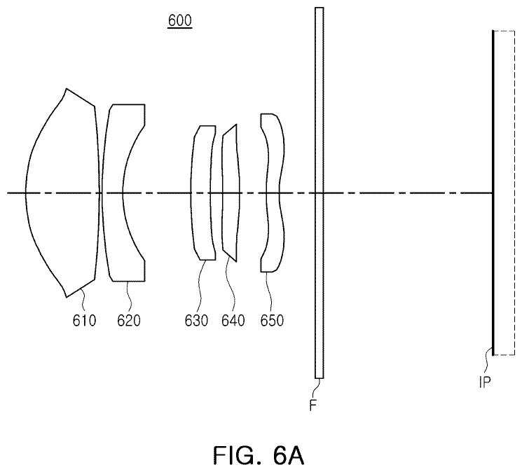

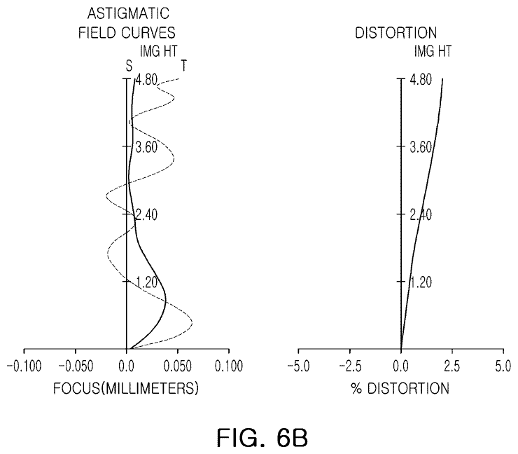

FIG. 6A is an optical imaging system configuration diagram according to a sixth embodiment of the present disclosure. FIG. 6B is a graph illustrating aberration characteristics of an optical imaging system according to a sixth embodiment of the present disclosure.

According to the sixth embodiment, the optical imaging system 600 may include a first lens 610, a second lens 620, a third lens 630, a fourth lens 640, and a fifth lens 650 arranged in order from an object side, and may further include an infrared blocking filter (F) and an image sensor (IP (Imaging Plane)) disposed on an image side of the fifth lens 650. In addition, although not illustrated in the drawing, an optical path conversion member (e.g., a prism) bending the path of incident light may be disposed on an object side of the first lens 610.

The first lens 610 may have positive refractive power. A focal length of the first lens 610 may be 5.0 mm or more. An object-side surface and an image-side surface of the first lens 610 may have a convex shape in a paraxial region. The first lens 610 may be formed of a plastic material. An Abbe number of the first lens 610 may be 50 or more. The first lens 610 may be an aspherical lens. For example, an object-side surface and an image-side surface of the first lens 610 may be aspherical. The first lens 610 may be a D-cut lens with a straight portion on the edge.

The second lens 620 may have negative refractive power. A focal length of the second lens 620 may be less than −5.0 mm. An object-side surface and an image-side surface of the second lens 620 may have a concave shape in a paraxial region. The second lens 620 may be formed of a plastic material. For example, the second lens 620 may be formed of a plastic material with different optical properties (refractive index and Abbe number) than the first lens 610. An Abbe number of the second lens 620 may be 20 or more. The second lens 620 may be an aspherical lens. For example, an object-side surface and an image-side surface of the second lens 620 may be aspherical.

The third lens 630 may have positive refractive power. A focal length of the third lens 630 may be 30.0 mm or more. An object-side surface of the third lens 630 may be convex in a paraxial region, and an image-side surface of the third lens 630 may be concave in the paraxial region. The third lens 630 may be formed of a plastic material. For example, the third lens 630 may be formed of a plastic material with different optical properties (refractive index and Abbe number) than the second lens 620. An Abbe number of the third lens 630 may be 20 or more. The third lens 630 may be an aspherical lens. For example, an object-side surface and an image-side surface of the third lens 630 may be aspherical.

The fourth lens 640 may have positive refractive power. A focal length of the fourth lens 640 may be 10.0 mm or more. An object-side surface of the fourth lens 640 may be concave in a paraxial region, and an image-side surface of the fourth lens 640 may be convex in the paraxial region. The fourth lens 640 may be formed of a plastic material. For example, the fourth lens 640 may be formed of a plastic material with different optical properties (refractive index and Abbe number) than the third lens 630. An Abbe number of the fourth lens 640 may be less than 20. The fourth lens 640 may be an aspherical lens. For example, an object-side surface and an image-side surface of the fourth lens 640 may be aspherical.

The fifth lens 650 may have negative refractive power. A focal length of the fifth lens 650 may be less than −10.0 mm. An object-side surface of the fifth lens 650 may be convex, and an image-side surface of the fifth lens 650 may be concave. The fifth lens 650 may be formed of a plastic material. For example, the fifth lens 650 may be formed of a plastic material with different optical properties (refractive index and Abbe number) than the fourth lens 640. An Abbe number of the fifth lens 650 may be 50 or more. The fifth lens 650 may be an aspherical lens. For example, an object-side surface and an image-side surface of the fifth lens 650 may be aspherical.

The focal length of the optical imaging system 600, according to the sixth embodiment of the present disclosure, may be 14.337 mm, TTL may be 13.300 mm, BFL may be 6.090 mm, IMG HT may be 4.595 mm, f value may be 2.62, and HFOV may be 17.45°.

Table 11 below illustrates optical and physical parameters of the optical imaging system 600 according to the sixth embodiment of the present disclosure.

TABLE 11

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.832 | 2.098 | 1.536 | 55.70 | 6.332 | 2.74(2.70) |
| 3 | −24.252 | 0.060 | | | | 2.55 |
| 4 | 7.693 | 0.609 | 1.640 | 23.96 | −7.581 | 2.33 |
| 5 | 2.882 | 1.927 | | | | 1.94 |
| 6 | 14.167 | 0.558 | 1.619 | 25.94 | 175.489 | 1.76 |
| 7 | 16.048 | 0.351 | | | | 1.73 |
| 8 | −14.273 | 0.467 | 1.677 | 19.24 | 35.451 | 1.76 |
| 9 | −9.068 | 0.760 | | | | 1.83 |
| 10 | 3.508 | 0.381 | 1.546 | 55.99 | −25.795 | 1.91 |
| 11 | 2.700 | 1.000 | | | | 2.13 |
| 12 | Infinity | 0.210 | 1.518 | 64.20 | | 5.00 |
| 13 | Infinity | 4.880 | | | | 5.00 |
| Image | Infinity | | | | | |

Table 12 below illustrates aspheric data of the optical imaging system 600 according to the sixth embodiment of the present disclosure.

TABLE 12

| Surface | 2 | 3 | 4 | 5 | 6 |
|---|---|---|---|---|---|
| K | −1.21E+00 | 1.12E+01 | −1.49E+01 | −1.68E−01 | −7.27E+01 |
| A | 3.28E−03 | 1.44E−02 | 2.46E−03 | −1.94E−02 | −4.20E−04 |
| B | −1.64E−03 | −2.60E−02 | −2.16E−02 | 1.44E−02 | −1.26E−03 |
| C | 2.11E−03 | 2.96E−02 | 2.33E−02 | −5.08E−02 | −1.07E−02 |
| D | −1.72E−03 | −2.25E−02 | −1.08E−02 | 1.21E−01 | 7.19E−02 |
| E | 9.21E−04 | 1.15E−02 | −2.88E−03 | −1.82E−01 | −1.87E−01 |
| F | −3.37E−04 | −3.96E−03 | 7.86E−03 | 1.84E−01 | 2.90E−01 |
| G | 8.48E−05 | 8.42E−04 | −5.80E−03 | −1.30E−01 | −2.99E−01 |
| H | −1.45E−05 | −7.73E−05 | 2.54E−03 | 6.60E−02 | 2.14E−01 |
| J | 1.57E−06 | −1.19E−05 | −7.46E−04 | −2.41E−02 | −1.09E−01 |
| L | −8.42E−08 | 5.32E−06 | 1.51E−04 | 6.29E−03 | 3.89E−02 |
| M | −2.04E−09 | −8.78E−07 | −2.08E−05 | −1.14E−03 | −9.61E−03 |
| N | 6.48E−10 | 8.09E−08 | 1.87E−06 | 1.37E−04 | 1.56E−03 |
| O | −4.04E−11 | −4.10E−09 | −9.97E−08 | −9.81E−06 | −1.51E−04 |
| P | 9.10E−13 | 8.96E−11 | 2.38E−09 | 3.15E−07 | 6.51E−06 |
| Surface | 7 | 8 | 9 | 10 | 11 |
| K | 3.70E+01 | 2.25E+01 | −1.13E+01 | −8.60E+01 | −3.50E+01 |
| A | −3.45E−03 | 1.38E−02 | 1.03E−03 | 1.17E−01 | 1.01E−01 |
| B | 8.63E−03 | 1.26E−02 | −7.71E−03 | −4.91E−01 | −3.27E−01 |
| C | −4.30E−02 | −4.16E−02 | 7.95E−02 | 1.10E+00 | 5.90E−01 |
| D | 1.52E−01 | 1.42E−01 | −2.02E−01 | −1.82E+00 | −7.85E−01 |
| E | −3.29E−01 | −3.31E−01 | 3.09E−01 | 2.22E+00 | 7.78E−01 |
| F | 4.62E−01 | 4.98E−01 | −3.26E−01 | −2.01E+00 | −5.73E−01 |
| G | −4.45E−01 | −5.07E−01 | 2.49E−01 | 1.35E+00 | 3.14E−01 |
| H | 3.02E−01 | 3.59E−01 | −1.41E−01 | −6.70E−01 | −1.28E−01 |
| J | −1.46E−01 | −1.80E−01 | 5.92E−02 | 2.46E−01 | 3.87E−02 |
| L | 4.97E−02 | 6.37E−02 | −1.84E−02 | −6.55E−02 | −8.47E−03 |
| M | −1.17E−02 | −1.55E−02 | 4.13E−03 | 1.23E−02 | 1.31E−03 |
| N | 1.81E−03 | 2.49E−03 | −6.30E−04 | −1.54E−03 | −1.36E−04 |
| O | −1.66E−04 | −2.36E−04 | 5.84E−05 | 1.16E−04 | 8.40E−06 |
| P | 6.81E−06 | 1.00E−05 | −2.49E−06 | −3.95E−06 | −2.36E−07 |

### Seventh Embodiment

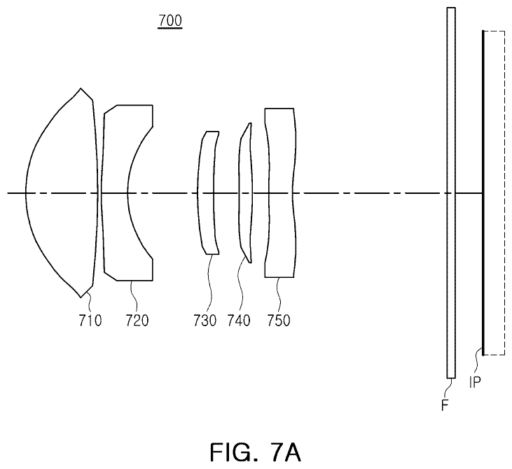

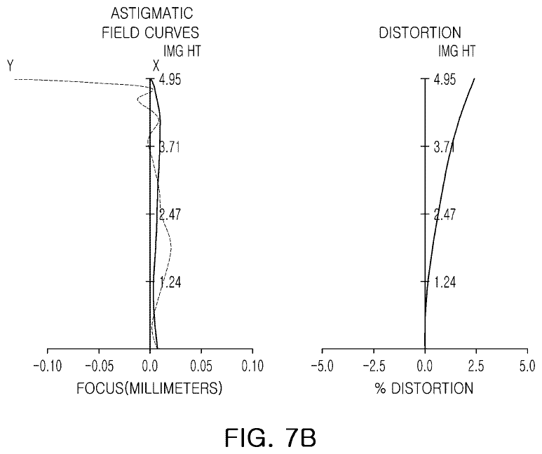

FIG. 7A is an optical imaging system configuration diagram according to a seventh embodiment of the present disclosure. FIG. 7B is a graph illustrating aberration characteristics of an optical imaging system according to a seventh embodiment of the present disclosure.

According to the seventh embodiment, the optical imaging system 700 may include a first lens 710, a second lens 720, a third lens 730, a fourth lens 740, and a fifth lens 750 arranged in order from an object side. It may include a lens 750 and may further include an infrared blocking filter (F) and an image sensor (IP (Imaging Plane)) disposed on an image side of the fifth lens 750. In addition, although not illustrated in the drawing, an optical path conversion member (e.g., a prism) bending the path of incident light may be disposed on an object side of the first lens 710.

The first lens 710 may have positive refractive power. A focal length of the first lens 710 may be 5.0 mm or more. An object-side surface and an image-side surface of the first lens 710 may have a convex shape in a paraxial region. The first lens 710 may be formed of a plastic material. An Abbe number of the first lens 710 may be 50 or more. The first lens 710 may be an aspherical lens. For example, an object-side surface and an image-side surface of the first lens 710 may be aspherical. The first lens 710 may be a D-cut lens with a straight portion on the edge.

The second lens 720 may have negative refractive power. A focal length of the second lens 720 may be less than −5.0 mm. An object-side surface and an image-side surface of the second lens 720 may have a concave shape in a paraxial region. The second lens 720 may be formed of a plastic material. For example, the second lens 720 may be formed of a plastic material with different optical properties (refractive index and Abbe number) from the first lens 710. An Abbe number of the second lens 720 may be 20 or more. The second lens 720 may be an aspherical lens. For example, an object-side surface and an image-side surface of the second lens 720 may be aspherical.

The third lens 730 may have positive refractive power. A focal length of the third lens 730 may be 30.0 mm or more. An object-side surface of the third lens 730 may be convex in a paraxial region, and an image-side surface of the third lens 730 may be concave in the paraxial region. The third lens 730 may be formed of a plastic material. For example, the third lens 730 may be formed of a plastic material with different optical properties (refractive index and Abbe number) than the second lens 720. An Abbe number of the third lens 730 may be 20 or more. The third lens 730 may be an aspherical lens. For example, an object-side surface and an image-side surface of the third lens 730 may be aspherical.

The fourth lens 740 may have positive refractive power. A focal length of the fourth lens 740 may be 10.0 mm or more. An object-side surface of the fourth lens 740 may be concave in a paraxial region, and an image-side surface of the fourth lens 740 may be convex in the paraxial region. The fourth lens 740 may be formed of a plastic material. For example, the fourth lens 740 may be formed of a plastic material with different optical properties (refractive index and Abbe number) than the third lens 730. An Abbe number of the fourth lens 740 may be 20 or more. The fourth lens 740 may be an aspherical lens. For example, an object-side surface and an image-side surface of the fourth lens 740 may be aspherical.

The fifth lens 750 may have negative refractive power. A focal length of the fifth lens 750 may be less than −10.0 mm. An object-side surface of the fifth lens 750 may be convex, and an image-side surface of the fifth lens 750 may be concave. The fifth lens 750 may be formed of a plastic material. For example, the fifth lens 750 may be formed of a plastic material with different optical properties (refractive index and Abbe number) than the fourth lens 740. An Abbe number of the fifth lens 750 may be 50 or more. The fifth lens 750 may be an aspherical lens. For example, an object-side surface and an image-side surface of the fifth lens 750 may be aspherical.

The focal length of the optical imaging system 700, according to the seventh embodiment of the present disclosure, may be 14.337 mm, TTL may be 13.308 mm, BFL may be 5.547 mm, IMG HT may be 4.595 mm, f value may be 2.54, and HFOV may be 17.45°.

Table 13 below illustrates optical and physical parameters of the optical imaging system 700 according to the seventh embodiment of the present disclosure.

TABLE 13

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.607 | 2.098 | 1.536 | 55.70 | 5.627 | 2.82(2.70) |
| 3 | −14.684 | 0.100 | | | | 2.60 |
| 4 | 11.523 | 0.755 | 1.619 | 25.90 | −5.557 | 2.38 |
| 5 | 2.583 | 2.046 | | | | 1.86 |
| 6 | 12.315 | 0.460 | 1.667 | 20.38 | 82.995 | 1.65 |
| 7 | 15.605 | 0.747 | | | | 1.67 |
| 8 | −21.858 | 0.391 | 1.619 | 25.90 | 17.438 | 1.91 |
| 9 | −7.277 | 0.477 | | | | 2.02 |
| 10 | 12.355 | 0.688 | 1.545 | 56.11 | −16.607 | 2.06 |
| 11 | 5.126 | 4.500 | | | | 2.28 |
| 12 | Infinity | 0.210 | 1.518 | 64.20 | | 5.00 |
| 13 | Infinity | 0.830 | | | | 5.00 |
| Image | Infinity | | | | | |

Table 14 below illustrates aspheric data of the optical imaging system 700 according to the seventh embodiment of the present disclosure.

TABLE 14

| Surface | 2 | 3 | 4 | 5 | 6 |
|---|---|---|---|---|---|
| K | −8.62E−01 | −4.99E+01 | −4.04E+01 | −1.06E−01 | 2.31E+00 |
| A | 2.03E−03 | 3.74E−03 | −7.88E−03 | −2.11E−02 | −3.14E−04 |
| B | 1.19E−03 | 2.07E−03 | 6.04E−03 | 1.11E−02 | −5.83E−03 |
| C | −1.85E−03 | −8.17E−03 | −1.51E−02 | −2.70E−02 | 1.44E−02 |
| D | 1.99E−03 | 1.03E−02 | 2.34E−02 | 6.47E−02 | −2.13E−02 |
| E | −1.43E−03 | −7.87E−03 | −2.36E−02 | −1.12E−01 | 1.84E−02 |
| F | 7.15E−04 | 4.12E−03 | 1.67E−02 | 1.39E−01 | 1.66E−03 |
| G | −2.53E−04 | −1.53E−03 | −8.51E−03 | −1.24E−01 | −2.71E−02 |
| H | 6.41E−05 | 4.13E−04 | 3.14E−03 | 8.06E−02 | 3.74E−02 |
| J | −1.17E−05 | −8.07E−05 | −8.41E−04 | −3.78E−02 | −2.87E−02 |
| L | 1.53E−06 | 1.13E−05 | 1.62E−04 | 1.26E−02 | 1.42E−02 |
| M | −1.38E−07 | −1.12E−06 | −2.17E−05 | −2.94E−03 | −4.57E−03 |
| N | 8.28E−09 | 7.32E−08 | 1.93E−06 | 4.51E−04 | 9.41E−04 |
| O | −2.94E−10 | −2.87E−09 | −1.02E−07 | −4.10E−05 | −1.12E−04 |
| P | 4.69E−12 | 5.08E−11 | 2.45E−09 | 1.68E−06 | 5.89E−06 |
| Surface | 7 | 8 | 9 | 10 | 11 |
| K | −8.03E+01 | 2.25E+01 | −2.99E+01 | −8.60E+01 | −6.78E+01 |
| A | 1.04E−03 | 2.73E−02 | 1.69E−02 | −2.69E−02 | 2.37E−02 |
| B | 2.05E−03 | −1.10E−02 | −1.25E−02 | −2.20E−03 | −6.11E−02 |
| C | −1.61E−02 | 3.35E−03 | 2.27E−02 | 1.25E−02 | 7.88E−02 |
| D | 2.95E−02 | 1.20E−02 | −2.89E−02 | −1.11E−02 | −7.82E−02 |
| E | −7.48E−03 | −3.50E−02 | 2.42E−02 | −2.40E−04 | 5.95E−02 |
| F | −6.15E−02 | 5.21E−02 | −1.09E−02 | 1.20E−02 | −3.43E−02 |
| G | 1.31E−01 | −5.06E−02 | −6.19E−04 | −1.50E−02 | 1.48E−02 |
| H | −1.43E−01 | 3.41E−02 | 4.63E−03 | 1.04E−02 | −4.80E−02 |
| J | 9.91E−02 | −1.62E−02 | −3.43E−03 | −4.67E−03 | 1.15E−03 |
| L | −4.60E−02 | 5.44E−03 | 1.42E−03 | 1.42E−03 | −2.00E−04 |
| M | 1.43E−02 | −1.26E−03 | −3.69E−04 | −2.93E−04 | 2.45E−05 |
| N | −2.85E−03 | 1.91E−04 | 6.03E−05 | 3.89E−05 | −2.01E−06 |
| O | 3.31E−04 | −1.71E−05 | −5.66E−06 | −3.03E−06 | 9.83E−08 |
| P | −1.70E−05 | 6.84E−07 | 2.33E−07 | 1.05E−07 | −2.18E−09 |

### Eighth Embodiment

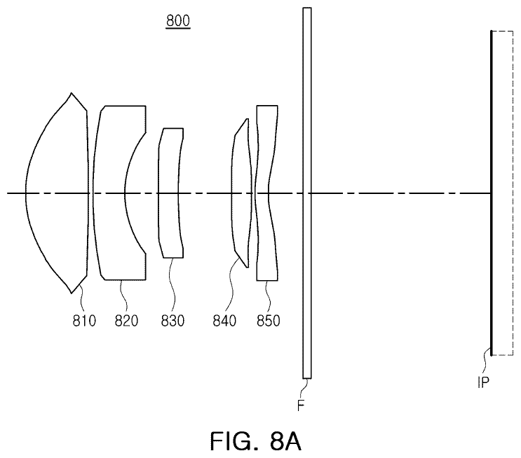

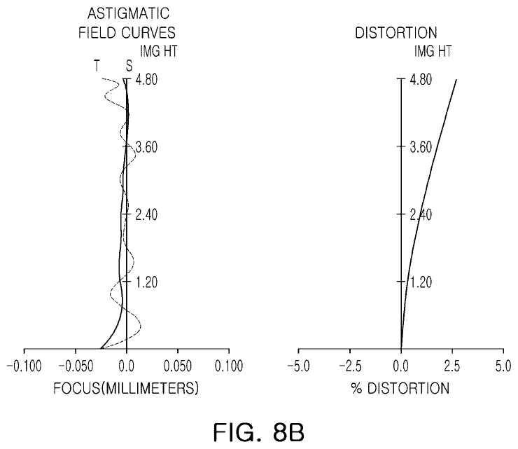

FIG. 8A is an optical imaging system configuration diagram according to an eighth embodiment of the present disclosure. FIG. 8B is a graph illustrating aberration characteristics of an optical imaging system according to an eighth embodiment of the present disclosure.

According to the eighth embodiment, the optical imaging system 800 may include a first lens 810, a second lens 820, a third lens 830, a fourth lens 840, and a fifth lens arranged in order from an object side, and may further include an infrared blocking filter (F) and an image sensor (IP (Imaging Plane)) disposed on an image side of the fifth lens 850. In addition, although not illustrated in the drawing, an optical path conversion member (e.g., a prism) that bends the path of incident light may be disposed on the object side of the first lens 810.

The first lens 810 may have positive refractive power. A focal length of the first lens 810 may be 5.0 mm or more. An object-side surface and an image-side surface of the first lens 810 may have a convex shape in a paraxial region. The first lens 810 may be formed of a plastic material. An Abbe number of the first lens 810 may be 50 or more. The first lens 810 may be an aspherical lens. For example, an object-side surface and an image-side surface of the first lens 810 may be aspherical. The first lens 810 may be a D-cut lens having a straight portion on the edge.

The second lens 820 may have negative refractive power. A focal length of the second lens 820 may be less than −5.0 mm. An object-side surface of the second lens 820 may be convex in a paraxial region, and an image-side surface of the second lens 820 may be concave in the paraxial region. The second lens 820 may be formed of a plastic material. For example, the second lens 820 may be formed of a plastic material with different optical properties (refractive index and Abbe number) than the first lens 810. An Abbe number of the second lens 820 may be 20 or more. The second lens 820 may be an aspherical lens. For example, an object-side surface and an image-side surface of the second lens 820 may be aspherical.

The third lens 830 may have negative refractive power. A focal length of the third lens 830 may be less than −20.0 mm. An object-side surface of the third lens 830 may be convex in a paraxial region, and an image-side surface of the third lens 830 may be concave in the paraxial region. The third lens 830 may be formed of a plastic material. For example, the third lens 830 may be formed of a plastic material with different optical properties (refractive index and Abbe number) than the second lens 820. An Abbe number of the third lens 830 may be less than 20. The third lens 830 may be an aspherical lens. For example, an object-side surface and an image-side surface of the third lens 830 may be aspherical.

The fourth lens 840 may have positive refractive power. A focal length of the fourth lens 840 may be 10.0 mm or more. An object-side surface of the fourth lens 840 may be concave in a paraxial region, and an image-side surface of the fourth lens 840 may be convex in the paraxial region. The fourth lens 840 may be formed of a plastic material. For example, the fourth lens 840 may be formed of a plastic material with different optical properties (refractive index and Abbe number) than the third lens 830. An Abbe number of the fourth lens 840 may be 20 or more. The fourth lens 840 may be an aspherical lens. For example, an object-side surface and an image-side surface of the fourth lens 840 may be aspherical.

The fifth lens 850 may have negative refractive power. A focal length of the fifth lens 850 may be less than −10.0 mm. An object-side surface of the fifth lens 850 may be convex, and an image-side surface of the fifth lens 850 may be concave. The fifth lens 850 may be formed of a plastic material. For example, the fifth lens 850 may be formed of a plastic material with different optical properties (refractive index and Abbe number) than the fourth lens 840. An Abbe number of the fifth lens 850 may be 50 or more. The fifth lens 850 may be an aspherical lens. For example, an object-side surface and an image-side surface of the fifth lens 850 may be aspherical.

The focal length of the optical imaging system 800, according to the eighth embodiment of the present disclosure, may be 14.417 mm, TTL may be 13.547 mm, BFL may be 6.487 mm, IMG HT may be 4.621 mm, f value may be 2.65, and HFOV may be 17.45°.

Table 15 below illustrates optical and physical parameters of the optical imaging system 800 according to the eighth embodiment of the present disclosure.

TABLE 15

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.657 | 1.818 | 1.536 | 55.70 | 6.395 | 2.74(2.70) |
| 3 | −45.252 | 0.120 | | | | 2.58 |
| 4 | 7.472 | 0.961 | 1.619 | 25.90 | −7.439 | 2.34 |
| 5 | 2.710 | 0.962 | | | | 1.81 |
| 6 | 146.120 | 0.574 | 1.676 | 19.23 | −28.851 | 1.75 |
| 7 | 17.200 | 1.549 | | | | 1.65 |
| 8 | −688.039 | 0.589 | 1.619 | 25.90 | 12.019 | 2.00 |
| 9 | −7.366 | 0.100 | | | | 2.05 |
| 10 | 4.037 | 0.387 | 1.545 | 56.11 | −19.578 | 2.12 |
| 11 | 2.831 | 1.000 | | | | 2.35 |
| 12 | Infinity | 0.210 | 1.518 | 64.20 | | 5.00 |
| 13 | Infinity | 5.277 | | | | 5.00 |
| Image | Infinity | | | | | |

Table 16 below illustrates aspheric data of the optical imaging system 800 according to the eighth embodiment of the present disclosure.

TABLE 16

| Surface | 2 | 3 | 4 | 5 | 6 |
|---|---|---|---|---|---|
| K | −9.04E−01 | 1.38E+01 | −1.08E+01 | −1.08E−01 | 8.91E+01 |
| A | 2.57E−03 | 4.99E−03 | −2.53E−03 | −1.53E−02 | −1.43E−03 |
| B | 1.44E−04 | −4.36E−03 | −3.30E−03 | −6.49E−03 | 2.82E−03 |
| C | −9.59E−05 | 3.22E−03 | 1.46E−03 | 3.42E−02 | −1.30E−02 |
| D | 8.18E−05 | −2.45E−03 | 9.96E−04 | −9.72E−02 | 4.56E−02 |
| E | −4.12E−05 | 1.75E−03 | −2.32E−03 | 1.83E−01 | −9.81E−02 |
| F | 7.26E−06 | −9.82E−04 | 2.33E−03 | −2.35E−01 | 1.44E−01 |
| G | 3.92E−06 | 4.01E−04 | −1.51E−03 | 2.14E−01 | −1.48E−01 |
| H | −3.07E−06 | −1.19E−04 | 6.66E−04 | −1.39E−01 | 1.08E−01 |
| J | 1.01E−06 | 2.25E−05 | −2.05E−04 | 6.53E−02 | −5.65E−02 |
| L | −1.99E−07 | −3.92E−06 | 4.37E−05 | −2.19E−02 | 2.09E−02 |
| M | 2.48E−08 | 4.23E−07 | −6.39E−06 | 5.11E−03 | −5.34E−03 |
| N | −1.93E−09 | −3.04E−08 | 6.10E−07 | −7.89E−04 | 8.98E−04 |
| O | 8.62E−11 | 1.30E−09 | −3.42E−08 | 7.24E−05 | −8.93E−05 |
| P | −1.68E−12 | −2.53E−11 | 8.58E−10 | −2.99E−06 | 3.98E−06 |
| Surface | 7 | 8 | 9 | 10 | 11 |
| K | 8.49E+01 | 2.25E+01 | −1.49E+01 | −8.60E+01 | −2.58E+01 |
| A | 2.80E−03 | 3.06E−02 | 5.36E−02 | 1.32E−01 | 7.09E−02 |
| B | −1.06E−02 | −4.78E−02 | −1.82E−01 | −4.69E−01 | 1.92E−01 |
| C | 5.19E−02 | 8.80E−02 | 3.77E−01 | 9.03E−01 | 2.91E−01 |
| D | −1.48E−01 | −1.21E−01 | −5.14E−01 | −1.21E+00 | −3.19E−01 |
| E | 2.77E−01 | 1.20E−01 | 4.92E−01 | 1.18E+00 | 2.56E−01 |
| F | −3.48E−01 | −8.42E−02 | −3.39E−01 | −8.54E−01 | −1.52E−01 |
| G | 2.98E−01 | 4.24E−02 | 1.73E−01 | 4.59E−01 | 6.62E−02 |
| H | −1.73E−01 | −1.52E−02 | −6.56E−02 | −1.85E−01 | −2.14E−02 |
| J | 6.50E−02 | 3.75E−03 | 1.87E−02 | 5.55E−02 | 5.04E−03 |
| L | −1.39E−02 | −5.97E−04 | −3.94E−03 | −1.22E−02 | −8.56E−04 |
| M | 6.74E−04 | 4.95E−05 | 6.05E−04 | 1.92E−03 | 1.01E−04 |
| N | 4.33E−04 | 3.66E−07 | −6.42E−05 | −2.03E−04 | −7.87E−06 |
| O | −1.05E−04 | −4.42E−07 | 4.25E−06 | 1.29E−05 | 3.58E−07 |
| P | 7.83E−06 | 2.69E−08 | −1.32E−07 | −3.77E−07 | −7.15E−09 |

### Ninth Embodiment

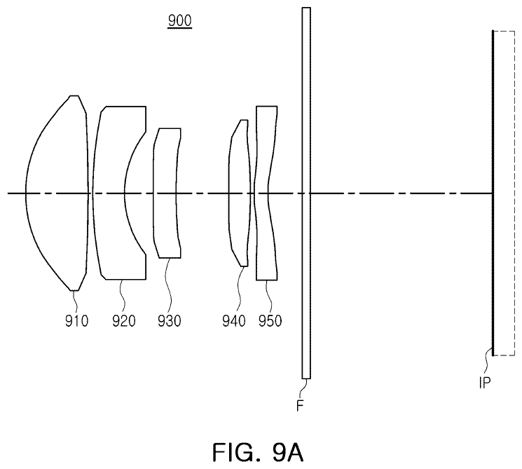

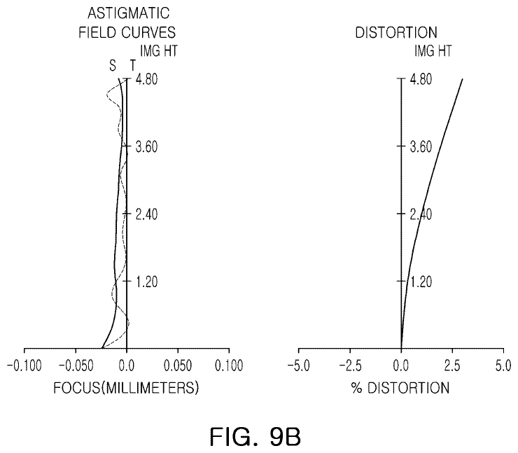

FIG. 9A is an optical imaging system configuration diagram according to a ninth embodiment of the present disclosure. FIG. 9B is a graph illustrating aberration characteristics of an optical imaging system according to a ninth embodiment of the present disclosure.

According to the ninth embodiment, the optical imaging system 900 may include a first lens 910, a second lens 920, a third lens 930, a fourth lens 940, and a fifth lens 950 arranged in order from an object side, and may further include an infrared blocking filter (F) and an image sensor (IP (Imaging Plane)) disposed on an image side of the fifth lens 950. In addition, although not illustrated in the drawing, an optical path conversion member (e.g., a prism) bending the path of incident light may be disposed on an object side of the first lens 910.

The first lens 910 may have positive refractive power. A focal length of the first lens 910 may be 5.0 mm or more. An object-side surface and an image-side surface of the first lens 910 may have a convex shape in a paraxial region. The first lens 910 may be formed of a plastic material. An Abbe number of the first lens 910 may be 50 or more. The first lens 910 may be an aspherical lens. For example, an object-side surface and an image-side surface of the first lens 910 may be aspherical. The first lens 910 may be a D-cut lens having a straight portion on the edge.

The second lens 920 may have negative refractive power. A focal length of the second lens 920 may be less than −5.0 mm. An object-side surface of the second lens 920 may be convex in a paraxial region, and an image-side surface of the second lens 920 may be concave in the paraxial region. The second lens 920 may be formed of a plastic material. For example, the second lens 920 may be formed of a plastic material with different optical properties (refractive index and Abbe number) from the first lens 910. An Abbe number of the second lens 920 may be 20 or more. The second lens 920 may be an aspherical lens. For example, an object-side surface and an image-side surface of the second lens 920 may be aspherical.

The third lens 930 may have negative refractive power. A focal length of the third lens 930 may be less than −20.0 mm. An object-side surface of the third lens 930 may be convex, and an image-side surface of the third lens 930 may be concave in a paraxial region. The third lens 930 may be formed of a plastic material. For example, the third lens 930 may be formed of a plastic material with different optical properties (refractive index and Abbe number) than the second lens 920. An Abbe number of the third lens 930 may be less than 20. The third lens 930 may be an aspherical lens. For example, an object-side surface and an image-side surface of the third lens 930 may be aspherical.

The fourth lens 940 may have positive refractive power. A focal length of the fourth lens 940 may be 10.0 mm or more. An object-side surface of the fourth lens 940 may be concave in a paraxial region, and an image-side surface of the fourth lens 940 may be convex in the paraxial region. The fourth lens 940 may be formed of a plastic material. For example, the fourth lens 940 may be formed of a plastic material with different optical properties (refractive index and Abbe number) than the third lens 930. An Abbe number of the fourth lens 940 may be 20 or more. The fourth lens 940 may be an aspherical lens. For example, an object-side surface and an image-side surface of the fourth lens 940 may be aspherical.

The fifth lens 950 may have negative refractive power. A focal length of the fifth lens 950 may be less than −10.0 mm. An object-side surface of the fifth lens 950 may be convex, and an image-side surface of the fifth lens 950 may be concave. The fifth lens 950 may be formed of a plastic material. For example, the fifth lens 950 may be formed of a plastic material with different optical properties (refractive index and Abbe number) than the fourth lens 940. An Abbe number of the fifth lens 950 may be 50 or more. The fifth lens 950 may be an aspherical lens. For example, an object-side surface and an image-side surface of the fifth lens 950 may be aspherical.

The focal length of the optical imaging system 900, according to the ninth embodiment of the present disclosure, may be 14.417 mm, TTL may be 13.608 mm, BFL may be 6.557 mm, IMG HT may be 4.621 mm, f value may be 2.65, and HFOV may be 17.27°.

Table 17 below illustrates optical and physical parameters of the optical imaging system 900 according to the ninth embodiment of the present disclosure.

TABLE 17

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.654 | 1.809 | 1.536 | 55.70 | 6.361 | 2.74(2.70) |
| 3 | −42.166 | 0.125 | | | | 2.59 |
| 4 | 7.418 | 0.951 | 1.619 | 25.90 | −7.338 | 2.34 |
| 5 | 2.680 | 0.819 | | | | 1.81 |
| 6 | 126.293 | 0.675 | 1.676 | 19.23 | −29.909 | 1.76 |
| 7 | 17.412 | 1.534 | | | | 1.65 |
| 8 | −380.683 | 0.638 | 1.619 | 25.90 | 12.008 | 2.00 |
| 9 | −7.298 | 0.100 | | | | 2.05 |
| 10 | 4.207 | 0.402 | 1.545 | 56.11 | −19.374 | 2.13 |
| 11 | 2.908 | 1.000 | | | | 2.35 |
| 12 | Infinity | 0.210 | 1.518 | 64.20 | | 5.00 |
| 13 | Infinity | 5.347 | | | | 5.00 |
| Image | Infinity | | | | | |

Table 18 below illustrates aspheric data of the optical imaging system 900 according to the ninth embodiment of the present disclosure.

TABLE 18

| Surface | 2 | 3 | 4 | 5 | 6 |
|---|---|---|---|---|---|
| K | −9.17E−01 | 1.29E+01 | −1.05E+01 | −9.57E−02 | −9.00E+01 |
| A | 2.53E−03 | 5.39E−03 | −1.88E−03 | −1.45E−02 | −1.41E−03 |
| B | 1.78E−04 | −6.62E−03 | −6.09E−03 | −9.57E−03 | 5.08E−03 |
| C | −1.73E−04 | 6.92E−03 | 6.49E−03 | 4.06E−02 | −2.74E−02 |
| D | 1.61E−04 | −6.07E−03 | −4.77E−03 | −1.07E−01 | 9.17E−02 |
| E | −9.23E−05 | 4.24E−03 | 2.51E−03 | 1.94E−01 | −1.92E−01 |
| F | 3.00E−05 | −2.23E−03 | −6.77E−04 | −2.45E−01 | 2.72E−01 |
| G | −3.13E−06 | 8.71E−04 | −1.14E−04 | 2.20E−01 | −2.70E−01 |
| H | −1.60E−06 | −2.50E−04 | 1.90E−04 | −1.42E−01 | 1.90E−01 |
| J | 8.19E−07 | 5.24E−05 | −8.64E−05 | 6.62E−02 | −9.58E−02 |
| L | −1.87E−07 | −7.93E−06 | 2.28E−05 | −2.20E−02 | 3.42E−02 |
| M | 2.53E−08 | 8.43E−07 | −3.82E−06 | 5.10E−03 | −8.46E−03 |
| N | −2.07E−09 | −5.96E−08 | 4.03E−07 | −7.81E−04 | 1.38E−03 |
| O | 9.58E−11 | 2.52E−09 | −2.45E−08 | 7.10E−05 | −1.33E−04 |
| P | −1.92E−12 | −4.81E−11 | 6.54E−10 | −2.90E−06 | 5.75E−06 |
| Surface | 7 | 8 | 9 | 10 | 11 |
| K | 8.41E+01 | 2.25E+01 | −1.52E+01 | −8.60E+01 | −2.64E+01 |
| A | 2.21E−03 | 2.42E−02 | 2.96E−02 | 9.25E−02 | 5.96E−02 |
| B | −2.60E−03 | −2.28E−02 | −7.39E−02 | −3.07E−01 | −1.51E−01 |
| C | 1.00E−02 | 3.19E−02 | 1.34E−01 | 5.62E−01 | 2.20E−01 |
| D | −1.54E−02 | −3.45E−02 | −1.59E−01 | −7.42E−01 | −2.37E−01 |
| E | −1.69E−03 | 2.30E−02 | 1.25E−01 | 7.24E−01 | 1.90E−01 |
| F | 5.79E−02 | −5.05E−03 | −6.27E−02 | −5.27E−01 | −1.13E−01 |
| G | −1.22E−01 | −5.93E−03 | 1.73E−02 | 2.88E−01 | 5.03E−02 |
| H | 1.40E−01 | 6.93E−03 | −7.16E−05 | −1.18E−01 | −1.66E−02 |
| J | −1.03E−01 | −3.78E−03 | −2.03E−03 | 3.64E−02 | 4.01E−03 |
| L | 5.04E−02 | 1.28E−03 | 8.75E−04 | −8.24E−03 | −7.02E−04 |
| M | −1.65E−02 | −2.86E−04 | −1.97E−04 | 1.33E−03 | 8.62E−05 |
| N | 3.44E−03 | 4.06E−05 | 2.62E−05 | −1.45E−04 | −7.01E−06 |
| O | −4.19E−04 | −3.36E−06 | −1.93E−06 | 9.59E−06 | 3.38E−07 |
| P | 2.25E−05 | 1.23E−07 | 6.07E−08 | −2.89E−07 | −7.27E−09 |

### Tenth Embodiment

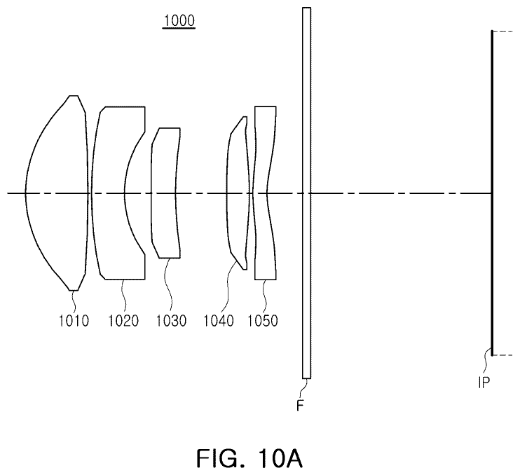

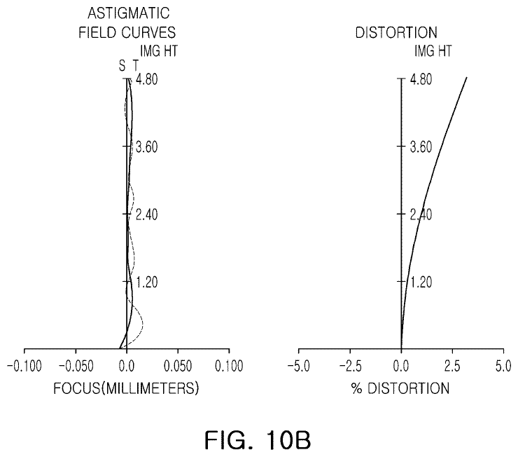

FIG. 10A is an optical imaging system configuration diagram according to a tenth embodiment of the present disclosure. FIG. 10B is a graph illustrating aberration characteristics of an optical imaging system according to a tenth embodiment of the present disclosure.

According to the tenth embodiment, the optical imaging system 1000 may include a first lens 1010, a second lens 1020, a third lens 1030, a fourth lens 1040, and a fifth lens 1050 arranged in order from an object side, and may further include an infrared blocking filter (F) and an image sensor (IP (Imaging Plane)) disposed on an image side of the fifth lens 1050. In addition, although not illustrated in the drawing, an optical path conversion member (e.g., a prism) bending the path of incident light may be disposed on an object side of the first lens 1010.

The first lens 1010 may have positive refractive power. A focal length of the first lens 1010 may be 5.0 mm or more. An object-side surface and an image-side surface of the first lens 1010 may have a convex shape in a paraxial region. The first lens 1010 may be formed of a plastic material. An Abbe number of the first lens 1010 may be 50 or more. The first lens 1010 may be an aspherical lens. For example, an object-side surface and an image-side surface of the first lens 1010 may be aspherical. The first lens 1010 may be a D-cut lens having a straight portion on the edge.

The second lens 1020 may have negative refractive power. A focal length of the second lens 1020 may be −5.0 mm or less. An object-side surface of the second lens 1020 may be convex in a paraxial region, and an image-side surface of the second lens 1020 may be concave in the paraxial region. The second lens 1020 may be formed of a plastic material. For example, the second lens 1020 may be formed of a plastic material with different optical properties (refractive index and Abbe number) than the first lens 1010. An Abbe number of the second lens 1020 may be 20 or more. The second lens 1020 may be an aspherical lens.

For example, an object-side surface and an image-side surface of the second lens 1020 may be aspherical.

The third lens 1030 may have negative refractive power. A focal length of the third lens 1030 may be −20.0 mm or less. An object-side surface of the third lens 1030 may be convex in a paraxial region, and an image side surface of the third lens 1030 may be concave in the paraxial region. The third lens 1030 may be formed of a plastic material. For example, the third lens 1030 may be formed of a plastic material with different optical properties (refractive index and Abbe number) than the second lens 1020. An Abbe number of the third lens 1030 may be less than 20. The third lens 1030 may be an aspherical lens. For example, an object-side surface and an image-side surface of the third lens 1030 may be aspherical.

The fourth lens 1040 may have positive refractive power. A focal length of the fourth lens 1040 may be 10.0 mm or more. An object-side surface of the fourth lens 1040 may be concave in a paraxial region, and an image-side surface of the fourth lens 1040 may be convex in the paraxial region. The fourth lens 1040 may be formed of a plastic material. For example, the fourth lens 1040 may be formed of a plastic material with different optical properties (refractive index and Abbe number) than the third lens 1030. An Abbe number of the fourth lens 1040 may be 20 or more. The fourth lens 1040 may be an aspherical lens. For example, an object-side surface and an image-side surface of the fourth lens 1040 may be aspherical.

The fifth lens 1050 may have negative refractive power. A focal length of the fifth lens 1050 may be less than −10.0 mm. An object-side surface of the fifth lens 1050 may be convex, and an image-side surface of the fifth lens 1050 may be concave. The fifth lens 1050 may be formed of a plastic material. For example, the fifth lens 1050 may be formed of a plastic material with different optical properties (refractive index and Abbe number) than the fourth lens 1040. An Abbe number of the fifth lens 1050 may be 50 or more. The fifth lens 1050 may be an aspherical lens. For example, an object-side surface and an image-side surface of the fifth lens 1050 may be aspherical.

The focal length of the optical imaging system 1000, according to the tenth embodiment of the present disclosure, may be 14.417 mm, TTL may be 13.612 mm, BFL may be 6.571 mm, IMG HT may be 4.621 mm, f value may be 2.64, and HFOV may be 17.28°.

Table 19 below illustrates optical and physical parameters of the optical imaging system 1000 according to the tenth embodiment of the present disclosure.

TABLE 19

| | | | Refrac- | | | Semi |
|---|---|---|---|---|---|---|
| | Radius of | Thickness/ | tive | Abbe | Focal | Aperture |
| Surface | Curvature | Distance | Index | number | Length | (D-cut) |
| Object | Infinity | Infinity | | | | |
| 1 | Infinity | 0.000 | | | | |
| 2 | 3.654 | 1.807 | 1.536 | 55.70 | 6.346 | 2.74(2.70) |
| 3 | −40.765 | 0.117 | | | | 2.59 |
| 4 | 7.398 | 0.950 | 1.619 | 25.90 | −7.299 | 2.34 |
| 5 | 2.668 | 0.797 | | | | 1.81 |
| 6 | 120.903 | 0.700 | 1.676 | 19.23 | −30.337 | 1.77 |
| 7 | 17.514 | 1.496 | | | | 1.65 |
| 8 | −381.732 | 0.661 | 1.619 | 25.90 | 12.028 | 2.00 |
| 9 | −7.311 | 0.100 | | | | 2.06 |
| 10 | 4.311 | 0.413 | 1.545 | 56.11 | −19.356 | 2.14 |
| 11 | 2.958 | 1.000 | | | | 2.35 |
| 12 | Infinity | 0.210 | 1.518 | 64.20 | | 5.00 |
| 13 | Infinity | 5.361 | | | | 5.00 |
| Image | Infinity | | | | | |

Table 20 below illustrates aspheric data of the optical imaging system 1000 according to the tenth embodiment of the present disclosure.

TABLE 20

| Surface | 2 | 3 | 4 | 5 | 6 |
|---|---|---|---|---|---|
| K | −9.20E−01 | 1.15E+01 | −1.04E+01 | −9.03E−02 | −9.00E+01 |
| A | 2.57E−03 | 4.76E−03 | −2.43E−03 | −1.57E−02 | −1.04E−03 |
| B | 7.24E−05 | −4.62E−03 | −4.01E−03 | 2.66E−04 | 3.57E−03 |
| C | −5.94E−05 | 3.42E−03 | 2.76E−03 | 1.61E−03 | −2.37E−02 |
| D | 1.09E−04 | −2.38E−03 | −8.32E−04 | −8.61E−03 | 8.70E−02 |
| E | −1.05E−04 | 1.67E−03 | −1.48E−04 | 2.49E−02 | −1.91E−01 |
| F | 6.02E−05 | −9.97E−04 | 5.10E−04 | −3.88E−02 | 2.79E−01 |
| G | −2.19E−05 | 4.44E−04 | −4.66E−04 | 3.82E−02 | −2.82E−01 |
| H | 5.21E−06 | −1.43E−04 | 2.55E−04 | −2.54E−02 | 2.01E−01 |
| J | −7.98E−07 | 3.30E−05 | −9.18E−05 | 1.16E−02 | −1.02E−01 |
| L | 7.41E−08 | −5.39E−06 | 2.22E−05 | −3.67E−03 | 3.68E−02 |
| M | −3.20E−09 | 6.11E−07 | −3.59E−06 | 7.81E−04 | −9.17E−03 |
| N | −6.09E−11 | −4.56E−08 | 3.73E−07 | −1.06E−04 | 1.50E−03 |
| O | 1.25E−11 | 2.02E−09 | −2.25E−08 | 8.26E−06 | −1.46E−04 |
| P | −3.83E−13 | −4.02E−11 | 6.03E−10 | −2.74E−07 | 6.34E−06 |
| Surface | 7 | 8 | 9 | 10 | 11 |
| K | 8.36E+01 | 2.25E+01 | −1.53E+01 | −8.60E+01 | −2.64E+01 |
| A | 2.06E−03 | 2.29E−02 | 2.59E−02 | 8.20E−02 | 5.54E−02 |
| B | −1.31E−03 | −1.82E−02 | −5.78E−02 | −2.64E−01 | −1.37E−01 |
| C | 3.19E−03 | 2.16E−02 | 9.98E−02 | 4.65E−01 | 1.94E−01 |
| D | 5.02E−03 | −1.87E−02 | −1.15E−01 | −5.93E−01 | −2.03E−01 |
| E | −4.18E−02 | 6.44E−03 | 8.96E−02 | 5.59E−01 | 1.60E−01 |
| F | 1.12E−01 | 6.87E−03 | −4.65E−02 | −3.92E−01 | −9.36E−02 |
| G | −1.74E−01 | −1.16E−02 | 1.55E−02 | 2.06E−01 | 4.08E−02 |
| H | 1.75E−01 | 8.52E−03 | −2.92E−03 | −8.11E−02 | −1.32E−02 |
| J | −1.20E−01 | −3.89E−03 | 1.28E−04 | 2.38E−02 | 3.14E−03 |
| L | 5.62E−02 | 1.18E−03 | 6.16E−05 | −5.13E−03 | −5.40E−04 |
| M | −1.78E−02 | −2.41E−04 | −9.48E−06 | 7.89E−04 | 6.51E−05 |
| N | 3.65E−03 | 3.16E−05 | −7.47E−07 | −8.19E−05 | −5.19E−06 |
| O | −4.38E−04 | −2.42E−06 | 2.81E−07 | 5.14E−06 | 2.45E−07 |
| P | 2.33E−05 | 8.25E−08 | −1.88E−08 | −1.47E−07 | −5.14E−09 |

Table 21 below illustrates optical and physical parameters related to the conditional equation of the optical imaging system according to the embodiments of the present disclosure. In the table below, the units of DL12, LD15, EDL1, EDL4, and F-CTn are all mm.

TABLE 21

| | Ex1 | Ex2 | Ex3 | Ex4 | Ex5 | Ex6 | Ex7 | Ex8 | Ex9 | Ex10 |
|---|---|---|---|---|---|---|---|---|---|---|
| AR1 | 0.957 | 0.957 | 0.957 | 0.957 | 0.957 | 0.986 | 0.957 | 0.986 | 0.986 | 0.986 |
| AR2 | 1 | 1 | 1 | 1 | 1 | 1 | 1 | 1 | 1 | 1 |
| DL12 | 2.786 | 2.836 | 2.702 | 2.987 | 2.944 | 2.767 | 2.953 | 2.899 | 2.884 | 2.874 |
| DL15 | 7.441 | 7.497 | 7.370 | 7.500 | 7.598 | 7.210 | 7.761 | 7.060 | 7.051 | 7.041 |
| EDL1 | 2.82 | 2.82 | 2.82 | 2.82 | 2.82 | 2.74 | 2.82 | 2.74 | 2.74 | 2.74 |
| EDL4 | 1.89 | 1.90 | 1.90 | 2.02 | 2.02 | 1.83 | 2.02 | 2.05 | 2.05 | 2.06 |
| ΣCTn | 3.390 | 3.445 | 3.516 | 4.430 | 3.322 | 3.265 | 3.703 | 3.942 | 4.072 | 4.118 |
| (n = 1, | | | | | | | | | | |
| 2, 3) | | | | | | | | | | |

According to the embodiments of the present disclosure, the telephoto ratio of an intermediate magnification camera may be reduced.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens having refractive power;
a second lens having negative refractive power;
a third lens having refractive power;
a fourth lens having positive refractive power; and
a fifth lens having negative refractive power,
wherein the first to fifth lenses are disposed in order from an object side, and
wherein 3.10<f/IMG HT<3.15 is satisfied,
where f is a focal length of the optical imaging system, and IMG HT is half of a diagonal length of an imaging plane.

2. The optical imaging system of claim 1, wherein 3.7≤TTL/ΣCTn(n=1, 2, 3)≤4.3 is satisfied,
where TTL is a distance on an optical axis from an object-side surface of the first lens to the imaging plane, and ΣCTn (n=1, 2, 3) is a sum of thicknesses on the optical axis of the first to third lenses.

3. The optical imaging system of claim 1, wherein the first lens has a convex image-side surface,
wherein 0.2≤R1/f≤0.3 is satisfied,
where R1 is a radius of curvature of an object-side surface of the first lens.

4. The optical imaging system of claim 1, wherein −2.5<f/f2+f/f3<−1.5 is satisfied,
where f2 is a focal length of the second lens, and f3 is a focal length of the third lens.

5. The optical imaging system of claim 1, wherein 2.0<TTL/f1≤2.5 is satisfied,
where TTL is a distance on an optical axis from an object-side surface of the first lens to the imaging plane, and f1 is a focal length of the first lens.

6. The optical imaging system of claim 1, wherein the third lens has positive refractive power and a convex object-side surface.

7. The optical imaging system of claim 1, wherein 2.15<f/BFL<2.60 is satisfied,
where BFL is a distance on an optical axis from an image-side surface of the fifth lens to the imaging plane.

8. The optical imaging system of claim 1, wherein the third lens has negative refractive power.

9. The optical imaging system of claim 1, wherein 5<d2/d1 is satisfied,
where d2 is a distance on an optical axis between an image-side surface of the second lens and an object-side surface of the third lens, and d1 is a distance on the optical axis between an image-side surface of the first lens and an object-side surface of the second lens.

10. The optical imaging system of claim 1, further comprising an optical path conversion member disposed on an object side of the first lens.

11. The optical imaging system of claim 1, wherein the optical imaging system has a total of five lenses.

12. An optical imaging system comprising:
a first lens, a second lens, a third lens, a fourth lens, and a fifth lens, sequentially arranged from an object side,
wherein 0.9≤TTL/f≤0.95 and 3.10<f/IMG HT<3.15 are satisfied,
where TTL is a distance on an optical axis from an object-side surface of the first lens to an imaging plane, f is a focal length of the optical imaging system, and IMG HT is half a diagonal length of the imaging plane.

13. The optical imaging system of claim 11, further comprising an optical path conversion member disposed on the object-side of the first lens.

14. The optical imaging system of claim 11, wherein 0.19<DL12/TTL<0.23 is satisfied,
where DL12 is a distance on the optical axis from the object-side surface of the first lens to an image-side surface of the second lens.

15. The optical imaging system of claim 11, wherein the first lens is a D-cut lens,
wherein 1.8<AR1+AR2<2.0 is satisfied,
where AR1 is an aspect ratio of a maximum effective diameter of the first lens, and AR2 is an aspect ratio of a maximum effective diameter of the second lens.

16. The optical imaging system of claim 11, wherein the fifth lens has a convex object-side surface and a concave image-side surface.

17. The optical imaging system of claim 11, wherein 0<|f/f3|<0.6 is satisfied,
where f3 is a focal length of the third lens.

18. The optical imaging system of claim 12, wherein the optical imaging system has a total of five lenses.
